(19) United States
(12) Patent Application Publication
(10) Pub. No.: US 2023/0297696 A1
(43) Pub. Date: Sep. 21, 2023

(54) CONFIDENTIAL COMPUTING USING PARALLEL PROCESSORS WITH CODE AND DATA PROTECTION

(71) Applicant: NVIDIA Corporation, Santa Clara, CA (US)

(72) Inventors: Philip Rogers, Austin, TX (US); Mark Overby, Bothell, WA (US); Vyas Venkataraman, Sharon, MA (US); Naveen Cherukuri, San Jose, CA (US); James Leroy Deming, Madison, AL (US); Gobikrishna Dhanuskodi, Santa Clara, CA (US); Dwayne Swoboda, San Jose, CA (US); Lucien Dunning, Ramsey, NJ (US); Aruna Manjunatha, Pleasanton, CA (US); Aaron Jiricek, Tualatin, OR (US); Mark Hairgrove, San Jose, CA (US); Michael Woodmansee, Sugarloaf Key, FL (US)

(21) Appl. No.: 18/185,654

(22) Filed: Mar. 17, 2023

Related U.S. Application Data
(60) Provisional application No. 63/322,187, filed on Mar. 21, 2022.

(51) Int. Cl. G06F 21/60; G06F 9/455; G06F 21/57

(52) U.S. Cl. CPC G06F 21/602; G06F 9/45558; G06F 21/575; G06F 2009/45587

(57) ABSTRACT

In examples, a parallel processing unit (PPU) operates within a trusted execution environment (TEE) implemented using a central processing unit (CPU). A virtual machine (VM) executing within the TEE is provided access to the PPU by a hypervisor. However, data of an application executed by the VM is inaccessible to the hypervisor and other untrusted entities outside of the TEE. To protect the data in transit, the VM and the PPU may encrypt or decrypt the data for secure communication between the devices. To protect the data within the PPU, a protected memory region may be created in PPU memory where compute engines of the PPU are prevented from writing outside of the protected memory region. A write protect memory region is generated where access to the PPU memory is blocked from other computing devices and/or device instances.

### RELATED APPLICATIONS

This application claims the benefit of U.S. Provisional Application No. 63/322,187, filed on Mar. 21, 2022, which is hereby incorporated by reference in its entirety.

### BACKGROUND

Virtualization enables multi-tenant environments to provide services to tenants using central processing units (CPUs) and parallel processing units (PPUs), such as graphics processing units (GPUs). Organizations that handle sensitive data such as Personally Identifiable Information (PII), financial data, or health information need to mitigate threats that target the confidentiality and integrity of applications and data in memory. However, securing processing units can be extremely difficult, especially when multiple tenants use the same physical computing resources. For example, while encrypted storage and network encryption have protected data at rest and data in transit, the ability to protect data and code while it is in use is limited in conventional computing infrastructures. Recently, a class of techniques known as confidential computing has been used to protect data in use by performing computations in a CPU-based Trusted Execution Environment (TEE) that prevents unauthorized access or modification of applications and data while in use.

Confidential computing approaches typically rely on hardware and firmware techniques to isolate user applications running on a confidential virtual machine (VM)— blocking access from higher privilege entities such as a hypervisor, virtual machine manager, and computer admins. The user applications execute in the CPU TEE, which protects the confidentiality and integrity of code and data from outside access by privileged software or physical attacks. Modern applications and workloads, such as those built on machine learning (ML) and artificial intelligence (AI) rely on accelerated computing to meet their performance requirements. However, conventional confidential computing is unable to protect data in use by PPUs. As such, the performance advantages offered by hardware accelerators have been forgone to meet security requirements.

### SUMMARY

Embodiments of the present disclosure relate to confidential computing using parallel processors. In particular, the disclosure relates to approaches that allow for secure execution environments that use parallel processing units (PPUs), such as graphics processing units (GPUs), to execute user code or perform other operations in a virtualized environment.

In contrast to conventional systems, a trusted execution environment (TEE) of a central processing unit (CPU) may be extended to include a PPU to provide accelerated confidential computing. In at least one embodiment, a PPU operates within a TEE implemented using a CPU and the PPU. An encrypted virtual machine (VM) executing within the TEE is provided access to the PPU by a hypervisor. However, data of an application executed by the encrypted VM is inaccessible to the hypervisor and other untrusted entities outside of the TEE, including direct memory access (DMA) by the PPU. To protect the data in transit, the VM and the PPU may encrypt or decrypt the data for secure communication between the devices. To protect the data within the PPU, a compute protected region (CPR) may be created in PPU memory. In one or more embodiments, the CPU and other devices are prevented from reading or writing to the CPR and the compute engines of the PPU are prevented from writing outside of the CPR.

### BRIEF DESCRIPTION OF THE DRAWINGS

The present systems and methods for confidential computing using parallel processors are described in detail below with reference to the attached drawing figures, wherein:

FIG. 1 depicts an example of a system including a trusted execution environment (TEE) having a parallel processing unit (PPU), in accordance with at least some embodiments of the present disclosure;

FIG. 2 depicts examples of configurations in a multi-PPU system, in accordance with at least some embodiments of the present disclosure;

FIG. 3 depicts an example of a system including a TEE having a PPU, in accordance with at least some embodiments of the present disclosure;

FIG. 4 illustrates an example of copy operations within a TEE having a PPU, in accordance with at least some embodiments of the present disclosure;

FIG. 5 illustrates an example of copy operations within a TEE having a PPU, in accordance with at least some embodiments of the present disclosure;

FIG. 6 illustrates an example of a memory layout for blocking interfaces from accessing GPU memory within a TEE having a PPU, in accordance with at least some embodiments of the present disclosure;

FIG. 7 illustrates an example of how a copy engine may encrypt or decrypt data based on a source or destination, in accordance with at least some embodiments of the present disclosure;

FIG. 8 illustrates an example of a certificate chain which may be used to authenticate a PPU, in accordance with at least some embodiments of the present disclosure;

FIG. 9 is a flow diagram showing a method a PPU may use to process data within a TEE, in accordance with at least some embodiments of the present disclosure;

FIG. 10 is a flow diagram showing a method a CPU may use to process data using a PPU within a TEE, in accordance with at least some embodiments of the present disclosure;

FIG. 11 is a flow diagram showing a method for copying data from CPU memory to GPU memory within a TEE that includes a PPU, in accordance with at least some embodiments of the present disclosure;

FIG. 12 is a flow diagram showing a method for copying data from GPU memory to CPU memory within a TEE that includes a PPU, in accordance with at least some embodiments of the present disclosure;

FIG. 13 depicts an example of a system including a trusted execution environment (TEE) having at least one instance of a PPU, in accordance with at least some embodiments of the present disclosure;

FIG. 14 depicts examples of configurations in a multi-instance PPU system, in accordance with at least some embodiments of the present disclosure;

FIG. 15 illustrates an example of a PPU having isolated PPU instances, in accordance with at least some embodiments of the present disclosure;

FIG. 16 is a flow diagram showing a method a PPU may use to process data within a TEE using a PPU instance, in accordance with at least some embodiments of the present disclosure;

FIG. 17 is a block diagram of an example computing device suitable for use in implementing some embodiments of the present disclosure; and

FIG. 18 is a block diagram of an example data center suitable for use in implementing some embodiments of the present disclosure.

### DETAILED DESCRIPTION

The present disclosure relates to confidential computing using parallel processors. In particular, the disclosure relates to approaches that allow for secure execution environments that use parallel processing units (PPUs), such as graphics processing units (GPUs), to execute user code or perform other operations in a virtualized environment.

In one or more embodiments, a central processing unit (CPU) trusted execution environment (TEE) may be extended to include one or more PPUs to provide accelerated confidential computing. The present disclosure focuses on examples where the one or more PPUs include one or more GPUs but is not limited to embodiments where the one or more PPUs include one or more GPUs. Further, the present disclosure focuses on examples where CPUs use PPUs, but various aspects apply more generally to processors using PPUs.

In at least one embodiment, a PPU operates within a TEE implemented, at least in part, using one or more central processing units (CPUs) or other devices. As used herein, a device may refer to a physical device or virtual device (e.g., a virtual instance of a device). In at least one embodiment, an encrypted virtual machine executing within the TEE is provided access to the PPU by a hypervisor. However, data of an application executed by the encrypted virtual machine may be inaccessible to the hypervisor and/or untrusted entities outside of the TEE. To protect the data in transit, the VM and the PPU may encrypt or decrypt the data for secure communication between the devices. To protect the data within the PPU, the PPU memory may be protected using various techniques. In at least one embodiment, a protected memory region is created where compute engines of the PPU are blocked or otherwise prevented from writing outside of the protected memory region once the compute engines have accessed one or more memory ranges within the protected memory region. In one or more embodiments, at least one protected memory region is generated where access to the PPU memory is blocked from other computing devices and/or device instances (e.g., from a CPU accessing the PPU memory across a system bus or other communication channel). In one or more embodiments the two protected memory regions may overlap or cover the same memory address range. Protected memory regions described herein may be encrypted or unencrypted in various embodiments.

In at least one embodiment, the TEE may include a CPU TEE and a GPU TEE, each of which may be hardware-based. Applications running in the CPU TEE may accelerate corresponding workloads on a GPU corresponding to the GPU TEE without compromising security or confidentiality. In one or more embodiments, applications can run on GPUs in a confidential VM. The applications (e.g., application code) need not to be modified to support accelerated confidential computing and need not have to refactor to determine which data to protect and which to leave unprotected. Instead, all data of the applications may be protected automatically.

Typically, the hypervisor of a CPU can map GPU memory across a device interface and read the GPU memory. All data that crosses the device interface is in plain text and can be read, for example, using an interposer attack or by the hypervisor, which may be untrusted. In one or more embodiments, the ability of untrusted entities, such as the hypervisor, a cloud service provider (CSP) owner, a CSP operator, a CSP administrator, and/or an enterprise IT administrator may be blocked from accessing data and code inside the GPU TEE to maintain confidentiality of user data. In one or more embodiments, GPU memory may be protected from software attacks, basic physical attacks, software roll-back attacks, cryptographical attacks, data roll-back attacks, and replay attacks.

In at least one embodiment, the TEE may be implemented using, for example and without limitation at least one of: one or more hardware firewalls of a GPU preventing ingress or egress using a device interface bus (e.g., except for engines with encryption capability enabled); one or more hardware firewalls of the GPU preventing ingress or egress using a device-to-device interface bus (e.g., except for engines with encryption capability enabled); one or more engines of the GPU (e.g., a copy engine) with encryption hardware for inline encrypt/decrypt operations; one or more engines of the GPU (e.g., a copy engine) to decrypt incoming command buffers (also referred to as push buffers) from the VM of the CPU; one or more engines (e.g., a copy engine) of the GPU to decrypt incoming kernels from the VM of the CPU; or one or more engines of the GPU (e.g., a copy engine) to encrypt synchronization signals to the VM of the CPU. Example engines may include (for example and without limitation) one or more hardware engines, such as one or more copy engines. Further, where engines are described herein with respect to different functionality, the various functionality may be implemented using the same or different engine(s). For example, one engine(s) may be used to implement multiple sets of functionalities or multiple engine(s) may be used to implement a respective one of the sets of functionalities (e.g., one or more dedicated engines for each set of functionality).

The TEE may further be implemented using an internal hardware root of trust (ROT) and a secure processor. The TEE may be implemented using an automatic disable of high-frequency in-band and out-of-band metrics counters when in a confidential compute mode to protect against side-channel attacks. The GPU may have the capability to execute with confidential compute protections disabled (e.g., regular operation), when a confidential compute mode is turned on (e.g., confidential protections enabled), and when a developer confidential compute mode is enabled. In a developer confidential compute mode confidential protections may be disabled but firmware and software may use the same paths as the confidential compute mode to enable debugging and profiling of issues that may show up when the confidential compute mode is turned on, but not when the a confidential compute mode is disabled.

In at least one embodiment, the TEE is implemented using, for example and without limitation, a unique key pair per GPU (or GPU instance in at least some embodiments) with a private key burned into fuses of the GPU, a security microcontroller used to encrypt/decrypt data to establish a secure enclave in memory of the GPU, and/or a combination of hardware, firmware, and microcode to attest the state of the GPU, to enable or disable a confidential compute mode, and/or to establish a secure communication channel (e.g., using a shared symmetric session key).

In at least one embodiment, the TEE is implemented using, for example, the VM (e.g., including one or more drivers) to determine when a GPU is in a confidential compute mode, configure bounce buffers outside of the CPU TEE for use in encrypted communication to the GPU, encrypt and sign all system memory corresponding to the CPU TEE for GPU memory transfers via the bounce buffers, program a copy engine of the GPU TEE to fetch and decrypt transferred data into GPU protected memory, encrypt and sign GPU memory to system memory transfers based at least on programming a copy engine of the GPU TEE to copy/encrypt transfer data to the bounce buffers, encrypt and sign GPU memory to GPU memory transfers over a device-to-device interface based at least in part by programming a copy engine of the GPU TEE on a source GPU to encrypt to transfer data to a GPU memory bounce buffer outside of the GPU TEE of the source GPU and a copy engine of a destination GPU to copy/decrypt transfer data into protected GPU memory, encrypt GPU push buffers and kernels sent to the GPU (which may then be decrypted by copy engine hardware before being executed), and/or encrypt and sign GPU synchronization signals sent from the GPU.

The systems and methods described herein may be used for a variety of purposes, by way of example and without limitation, these purposes may include systems or applications for online multiplayer gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

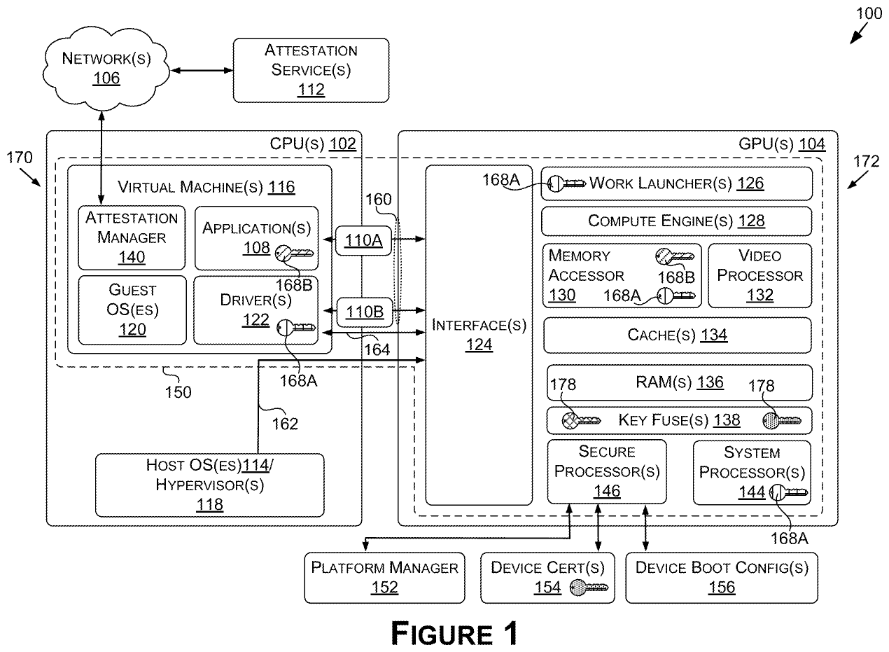

FIG. 1 depicts an example of a system 100 including a TEE having a PPU, in accordance with at least some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 may be implemented using, among additional or alternative components, one or more processing units, such a CPU(s) 102, one or more PPUs, such as a GPU(s) 104, one or more networks, such as a network(s) 106, one or more platform managers, such as a platform manager(s) 152, one or more device certificates, such as a device certificate(s) 154, and one or more device boot configurations, such as a device boot configuration(s) 156.

The CPU(s) 102 may run one or more host OSes, such as a Host OS(es) 114, one or more virtual machines, such as a virtual machine(s) 116, and one or more hypervisors, such as a hypervisor(s) 118. The GPU(s) 104 may include one or more interfaces, such as an interface(s) 124, one or more work launchers, such as a work launcher(s) 126, one or more compute engines, such as a compute engine(s) 128, one or more memory accessors, such as a memory accessor(s) 130 (e.g., one or more copy engines), one or more video processors (e.g., video decoders), such as a video processor(s) 132, one or more caches, such as a cache(s) 134, one or more RAMs, such as a RAM(s) 136, one or more key fuses, such as a key fuse(s) 138, one or more secure processors, such as a secure processor(s) 146, and one or more system processors, such as a system processor(s) 144.

The VM 116 may include one or more attestation managers, such as an attestation manager(s) 140, one or more applications, such as an application(s) 108, one or more guest OSes, such as a Guest OS(es) 120, and one or more drivers, such as a driver(s) 122.

The attestation manager(s) 140 (e.g., running on the VM 116) may receive one or more attestation reports from the CPU 102 and/or the GPU 104. For example, the CPU 102 may generate at least one attestation report and provide the attestation report(s) to the attestation manager 140. Further, the GPU 104 may generate at least one attestation report and provide the attestation report(s) to the attestation manager 140. The attestation manager(s) 140 may provide data, using the network(s) 106, corresponding to the one or more attestation reports to an attestation service(s) 112. The attestation service 112 may verify the data indicates one or more properties of a composite TEE 150. The attestation service 112 may provide data, using the network(s) 106, indicating the composite TEE 150 has been verified. The data may cause the VM 116 and/or one or more applications or services external to the VM 116 to perform one or more operations (e.g., using the GPU 104).

Components of the system 100 may communicate over the network(s) 106. The network(s) 106 may include a wide area network (WAN) (e.g., the Internet, a public switched telephone network (PSTN), etc.), a local area network (LAN) (e.g., Wi-Fi, ZigBee, Z-Wave, Bluetooth, Bluetooth Low Energy (BLE), Ethernet, etc.), a low-power wide-area network (LPWAN) (e.g., LoRaWAN, Sigfox, etc.), a global navigation satellite system (GNSS) network (e.g., the Global Positioning System (GPS)), and/or another network type.

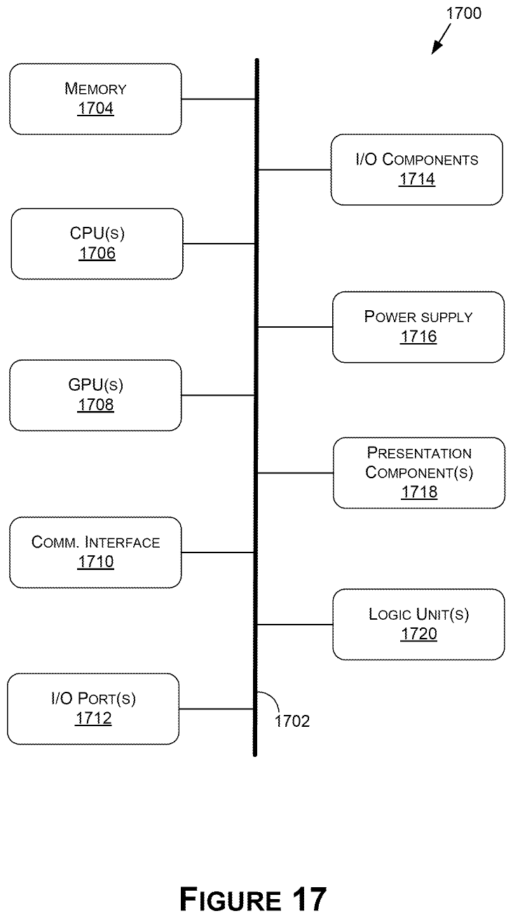

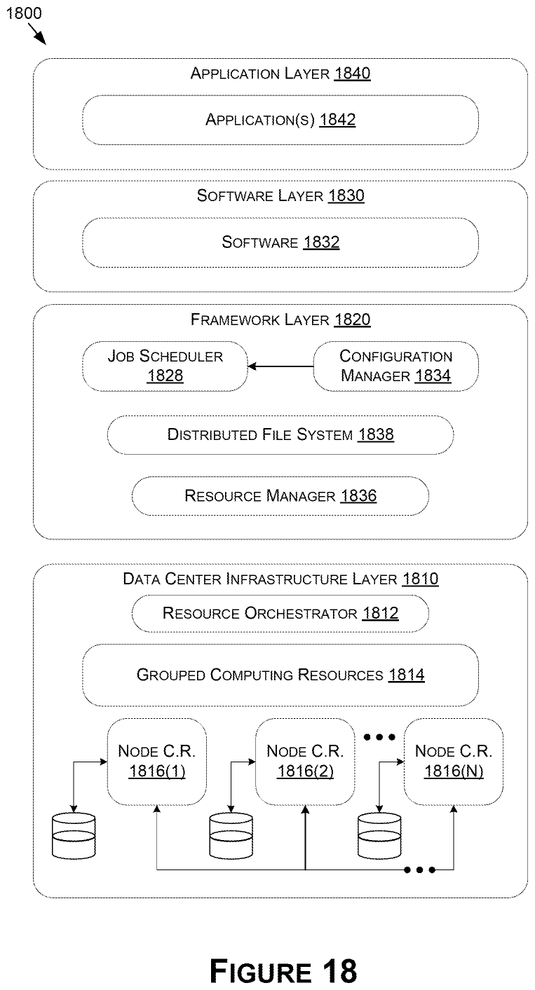

The CPU(s) 102 and the GPU(s) 104 may be implemented on one or more host systems, such as one or more host devices. Examples of a host system include one or more of a personal computer (PC), a smart phone, a laptop computer, a tablet computer, a desktop computer, a wearable device, a smart watch, a mobile device, a touch-screen device, a game console, a virtual reality system (e.g., a headset, a computer, a game console, remote(s), controller(s), and/or other components), a streaming device, (e.g., an NVIDIA SHIELD), a smart-home device that may include an intelligent personal assistant, a server, a data center, a Personal Digital Assistant (PDA), an MP3 player, a virtual reality headset, a Global Positioning System (GPS) or device, a video player, a video camera, a surveillance device or system, a vehicle, a boat, a flying vessel, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device. In at least one embodiment, the CPU 102 and the GPU 104 may be included in one or more of the computing device(s) 1700 of FIG. 17. In at least one embodiment, the CPU 102 and/or the GPU 104 may be included in the data center 1800 of FIG. 18.

The system 100, such as the CPU(s) 102 may execute the hypervisor 118 to enable virtualization and provide access to the underlying hardware of the system 100, such as the CPU(s) 102, the GPU(s) 104, system memory, and/or other components such as network interfaces, storage devices, or other physical hardware. The hypervisor 118 may provide access to various devices included or otherwise accessible to one or more servers. In at least one embodiment, the hypervisor 118 provides the VM 116 with access to the GPU 104 at least in part by providing virtualization of the GPU 104.

As shown in FIG. 1, the attestation manager 140 may be included in the VM(s) 116. As further examples, the attestation manager 140 may be included (e.g., implemented), at least in part, in one or more other VMs, software components, and/or devices, such as a different VM or trusted software or component (e.g., in the GPU 104, in another VM, etc.). In one or more embodiments, the attestation manager 140 may be included, at least in part, in one or more independent software vendor (ISV) applications, which may be programmed to refuse to run unless one or more properties of the composite TEE 150 are verified (e.g., to indicate a confidential environment). To enable policy enforcement and/or remote verification, the VM(s) 116 and/or other components of the system 100 may use, by way of example and not limitation, one or more of: a system guard runtime monitor (SGRM), secure boot, measured boot, virtualization-based security (VBS), dynamic root of trust for measurement (DRTM), or a device guard.

The attestation service 112 may be implemented in the same, similar, or different computing systems than the CPU(s) 102 and the GPU(s) 104. While the attestation service 112 is shown as communicating to the VM 116 over the network 106, in at least one embodiment, the attestation service 112 may be implemented in one or more host systems or devices that include the CPU(s) 102 and the GPU(s) 104. Thus, while the attestation service 112 is shown in FIG. 1 as communicating with the VM 116 and/or the attestation manager 140 over the network(s) 106, in at least one embodiment, different communication media and/or interfaces may be used. In at least one embodiment, the attestation service 112 is included in one or more servers.

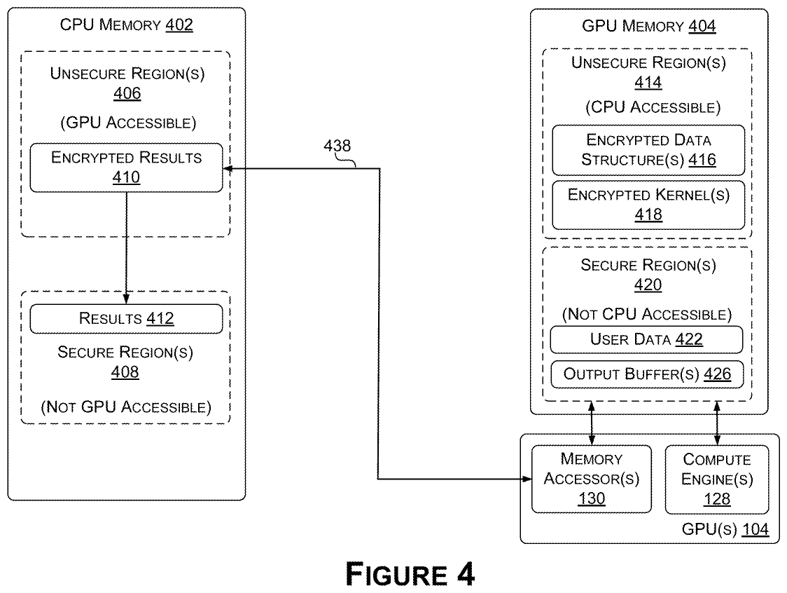

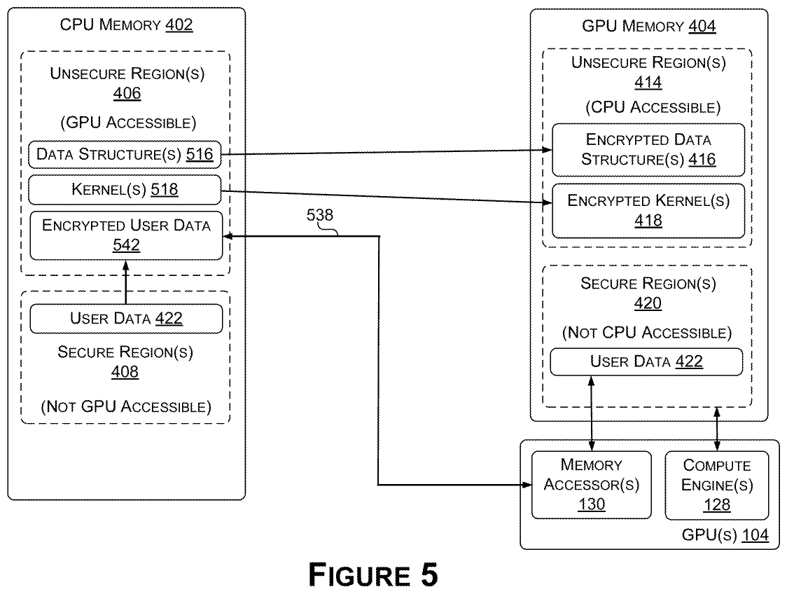

As described herein, the VM 116 may use the GPU 104 to perform one or more operations. For example, the VM 116 may communicate with the GPU 104 over the interface(s) 124 to perform one or more operations. The one or more operations may be performed using GPU state data associated with the VM 116 and/or the application 108 on the GPU 104. GPU state data may refer to data representing one or more variables, conditions, parameters, resources, device code, and/or other data used to perform one or more tasks using the GPU(s) 104, such as one or more parallel processing tasks. Driver data structures, kernels, and user data in FIGS. 4 and 5 are examples of GPU state data. Examples of the parallel processing tasks include tasks to implement one or more portions of the one or more operations, such as one or more operations for gaming, machine control, machine locomotion, machine driving, synthetic data generation, model training, perception, augmented reality, virtual reality, mixed reality, robotics, security and surveillance, autonomous or semi-autonomous machine applications, deep learning, generative AI, (large) language models, environment simulation, data center processing, conversational AI, light transport simulation (e.g., ray tracing, path tracing, etc.), collaborative content creation for 3D assets, digital twin systems, cloud computing and/or any other suitable applications.

Examples of the resources include objects such as modules and texture or surface references. A module may refer to a dynamically loadable package of device code and/or data. Device code symbols may include functions, global variables, and/or texture, surface, and/or resource references. In at least one embodiment, each set of GPU state data may have its own distinct address space, and values from the set of GPU state data may reference corresponding memory locations. In one or more embodiments, a set of GPU state data may include a GPU context, such as a compute unified device architecture (CUDA) context.

In one or more embodiments, the one or more operations may be performed, at least in part, using one or more applications running on the VM 116, such as the application(s) 108. The application 108 may include a game, a video streaming application, a machine control application, a machine locomotion application, a machine driving application, a synthetic data generation application, a model training application, a perception application, an augmented reality application, a virtual reality application, a mixed reality application, a robotics application, a security and surveillance application, an autonomous or semi-autonomous machine application, a deep learning application, an environment simulation application, a data center processing application, a generative AI application, an application using (large) language models, a conversational AI application, a light transport simulation application (e.g., ray tracing, path tracing, etc.), a collaborative content creation application for 3D assets, a digital twin system application, a cloud computing application and/or another type of application or service.

The application 108 may include a mobile application, a computer application, a console application, a tablet application, and/or another type of application. The application 108 may include instructions that, when executed by a processor(s) (e.g., the CPU 102 and/or the GPU 104), cause the processor(s) to, without limitation, configure, modify, update, transmit, process, and/or operate on the GPU state data, receive input data representative of user inputs to one or more input device(s), retrieve at least a portion of application data from memory, receive at least a portion of application data from a server(s), and/or cause display of data (e.g., image and/or video data) corresponding to the GPU state data on one or more displays. In one or more embodiments, the application(s) 108 may operate as a facilitator for enabling interacting with and viewing output from an application instance hosted on an application server using a client device(s).

As described herein, the attestation service 112 may verify the data indicates one or more properties of the composite TEE 150. For example, the attestation service 112 may track valid software and/or hardware configurations for the composite TEE 150 that include the one or more properties. By verifying the properties of the composite TEE 150, the VM 116, the application 108, an application server, and/or other devices, components, or entities may determine whether the composite TEE 150 is to operate in accordance with security policies and/or enforce those security policies. For example, one or more entities may determine the VM 116 is operating in environment that is to protect data and code associated with the VM 116 while it is in use, including data, such as GPU state data, processed using the GPU 104. Thus, in at least one embodiment, the attestation service 112 is used to ensure the CPU 102, the GPU 104, and/or other devices of the system 100 are operating in accordance with confidential computing.

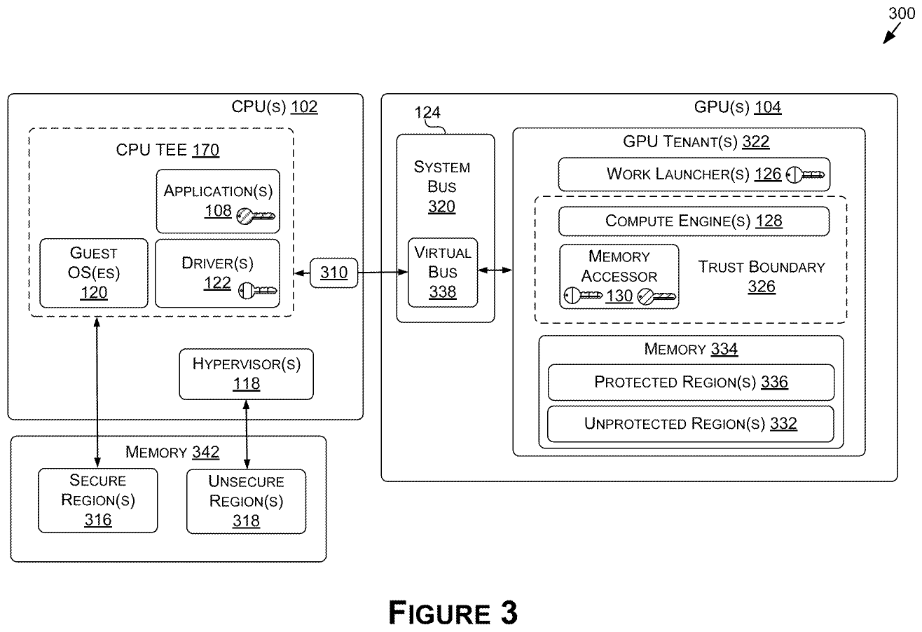

As described herein, the composite TEE 150 may include a TEE of the CPU(s) 102 (a CPU TEE 170) and a TEE of the GPU(s) 104 (a GPU TEE 172). The TEE of the CPU 102 may include, for example, the virtual machine 116. The TEE of the GPU 104 may include, for example, the interface 124, the work launcher 126, the compute engine 128, the memory accessor 130, the video processor 132, the cache 134, the RAM 136, the key fuses 138, the secure processor 146, and the system processor 144. In other examples, the TEE of the CPU(s) 102 and/or the TEE of the GPU(s) 104 may include more, fewer, and/or different components—such as those described with respect to FIGS. 3-5 and/or 13-15. In at least one embodiment, the composite TEE 150 may be secured using one or more cryptographic techniques, such as advanced encryption standard (AES) encryption. In at least one embodiment, the secure processor 146 (e.g., implementing standards for efficient cryptography 2 (SEC2)), the system processor 144, and/or the memory accessor 130 are configured to handle encryption and decryption, and may include respective cryptographic hardware (e.g., AES hardware). In at least one embodiment, the memory accessor 130 and the secure processor 146 are exposed to a user mode client, and the system processor 144 is exclusively used by a kernel model driver(s) 122 to communicate with the GPU(s) 104.

In one or more embodiments, the system 100 is configured to block unauthorized accesses from outside of the composite TEE 150. To support confidential computing workloads, only the VM 116 and the GPU 104 booted in a confidential compute mode may have access to sensitive data. All other entities, including all the interconnects, may not be trusted to have access to the sensitive data.

The interface(s) 124 may provide one or more communication channels 160 and 162 for communication between the CPU(s) 102 and the GPU(s) 104. For example, the communication channel(s) 162 may be for communication between the host OS(es) 114 and/or the hypervisor 118 and the GPU(s) 104. As indicated in FIG. 1, the communication channels 160 may include a communications channel(s) between the application(s) 108 and the GPU(s) 104 and a communications channel(s) between the driver(s) 122 and the GPU(s) 104.

The interfaces 124 include one or more physical interfaces and/or one or more virtual interfaces. In at least one embodiment, the interfaces 124 include one or more network interfaces, such as peripheral component interconnect express (PCIe) interfaces. By way of example, and not limitation, the physical interface(s) may include one or more physical functions and the virtual interface(s) may include one or more virtual functions.

In at least one embodiment, the communication channel(s) 162 may be used by the hypervisor 118 to indicate that after a reset of the GPU 104, the GPU 104 is to operate in a secure execution mode and/or a confidential compute mode, which establishes a GPU TEE 172 to be included in the composite TEE 150. For example, the hypervisor 118 may write data through an out of band (OOB) channel to a memory location(s) in a programmable read-only memory (PROM), such as an electrically erasable programmable read-only memory (EEPROM) attached to the GPU 104 (e.g., non-volatile memory). In at least one embodiment, the data corresponds to the device boot configuration 156 in FIG. 1. In at least one embodiment, the device boot configuration 156 and the device certificate 154 are included in the EEPROM.

Additionally, or alternatively, when the virtual machine 116 using the GPU 104 in the composite TEE 150 terminates, the hypervisor 118 may again use the communication channel(s) 162 to indicate to the GPU 104 to exit the secure execution mode and/or the confidential compute mode on the next reset (e.g., by writing data in the PROM). In various embodiments, the GPU 104 includes non-volatile memory to store data to indicate the GPU 104 is capable of generating the GPU TEE 172, that the GPU 104 is operating within the GPU TEE 172, that the GPU 104 is terminating the GPU TEE 172, and/or other information associated with the GPU 104. Any combination of this information may be used to generate an attestation report (e.g., provided by the GPU 104) to the attestation manager 140.

In at least one embodiment, at least a portion of the communication channel(s) 160 may be vulnerable to interposer attacks, for example, when the interface(s) 124 is connected to an exposed bus (e.g., external to a chip package(s) of the host device(s)). An exposed bus may be used, for example, where the GPU(s) 104 includes a discrete GPU (e.g., for CPU-GPU communication). In one or more embodiments, to ameliorate attack vectors associated with the communication channel(s) 160 and/or other attack vectors, at least one of the communication channels 160 and/or other communication channels may be encrypted. Further, the one or more properties of the composite TEE 150 that are verified using the attestation manager 140 may include that the communication channel(s) are encrypted and/or that non-encrypted/authenticated data is to be blocked.

The driver(s) 122 may include one or more user mode drivers and/or one or more kernel mode drivers. When referring to examples where a driver 122 is a kernel mode driver, the driver(s) 122 may be referred to as a kernel mode driver(s) 122. When referring to examples where a driver 122 is a user mode driver, the driver(s) 122 may be referred to as a user mode driver(s) 122. In at least one embodiment, functionality of a driver 122, such as a user mode driver 122 and/or a kernel mode driver 122 may be integrated, at least in part, into one or more components of the VM 116. For example, a user mode driver 122 may be integrated into an application 108. Components within the CPU TEE 170 (e.g., the application(s) 108, the guest OS(es) 120, and/or other components) can communicate with the GPU(s) 104 over the interface(s) 124 using the driver(s) 122. In at least one embodiment, the driver(s) 122 include code or other executable logic that, as a result of being executed by the CPU(s) 102, cause the system 100 to perform various operations that enable the application(s) 108 and/or other components of the CPU TEE 170 to use computing resources of the GPU(s) 104.

In one or more embodiments, the driver(s) 122 allow a machine learning application(s) executed within the CPU TEE 170 to use the GPU(s) 104 to perform inferencing operations. In at least one embodiment, the application(s) 108 may present GPU data (e.g., graphics data) to a GPU Application Programming Interface (API), such as OpenGL or DirectX, which may be implemented using a user mode driver 122. The user mode driver 122 may communicate the GPU data through a kernel mode driver 122, which may provide the GPU data for processing on the GPU 104 using the interface(s) 124.

In at least one embodiment, the VM 116 (e.g., the driver 122) may establish one or more secure communication channels (e.g., bi-directional encrypted communication channels), such as the communication channel(s) 160, using the interface(s) 124. In one or more embodiments, the VM 116 (e.g., the driver 122) encrypts all data transfers over the communication channels 160. In at least one embodiment, the VM 116 (e.g., the driver 122) encrypts and signs all kernels and GPU commands before they are transmitted across the interface(s) 124. At the GPU 104, these kernels and commands are decrypted into the GPU TEE 172 for execution. Similarly, synchronization primitives sent back to the CPU 102 may be encrypted by hardware and decrypted by the VM 116 (e.g., using the driver 122).

Establishing the one or more secure communication channels may include, for example, a handshake and/or initialization 164. In at least one embodiment, the handshake 164 may include the driver 122 and the GPU 104 performing a security protocol and data model (SPDM) key exchange (e.g., a Diffie-Hellman key exchange) to generate one or more shared symmetric session keys 168A and/or 168B (which may be referred to as a symmetric session key(s) 168) used by the VM(s) 116 and the GPU(s) 104 to encrypt and decrypt data for the secure channels corresponding to the communication channels 160. For example, a symmetric session key 168 may be created in the driver 122 and the GPU 104 during the initialization of the composite TEE 150. The cryptographic algorithm (e.g., AES-GCM-256) may use a symmetric key (e.g., a shared secret(s) 168) and an initialization vector (IV) (e.g., a 96b IV) as an input for either encrypting or decrypting data. The encryption may produce outputs including cipher data and an authentication tag (e.g., a MAC value of the input data). The cipher data may result in confidentiality and the authentication tag may be used for integrity checking.

During decryption, the authentication tag may be recalculated and compared with the input. Mismatch in the authentication tag may result in a decryption failure and/or termination of the GPU TEE 172.

In at least one embodiment, data encrypted using a key, IV pair can be decrypted only with the same key, IV pair. Any change in the pair may result in the authentication tag mismatch. Both the end points in an encrypted channel may use the same key, IV pair for successful communication.

In at least one embodiment, the unauthorized reuse of IVs may be prevented based at least on preventing reuse of a key, IV pair for encrypting at least two different data blocks. In at least one embodiment, the key of a pair may be constant over the life of a secure channel(s) (a secure session may switch channels multiple times), and IV reuse may be prevented in all encrypted channels. In at least one embodiment, IV reuse is prevented based at least on tracking all IVs used to ensure a current IV was not used in the past. Tracking the IVs may depend on the IV generation method used. In at least one embodiment, the IVs are randomly generated. In at least one embodiment, the IVs are deterministically constructed.

In at least one embodiment, the IVs may be deterministically constructed so that an IV gets incremented or otherwise computed for every encryption. In at least one embodiment, the IV always starts with 0 or some other predetermined value. A range or set of IVs that can be deterministically constructed for a key may be referred to as an IV space. For a 96b IV, the IV space may be from 0->(2\hat{ }96). In at least one embodiment, the entity that performs encryption tracks the last IV used for encryption and increments (or otherwise deterministically calculates) the last IV value before encryption, thereby avoiding IV reuse. Prior to the IV space overflowing (e.g., once the IV space is about to overflow), the key may be changed (e.g., based at least on determining the IV exceeds a threshold value) and the IV for the new key may start at the initial value (e.g., 0) or some other deterministic value. The incremented IV used for encryption may be communicated to the other end doing the decryption.

The encryption may be implemented using hardware accelerated encryption, hardware native encryption, and/or software encryption. In at least one embodiment, the VM 116 and the GPU 104 are to encrypt all network traffic sent to the interface(s) 124. In at least one embodiment, application state and related command and configuration data is encrypted on all buses external to the chip package(s). Additionally, or alternatively, data may be verified for integrity after exposure to any bus external to a chip package(s). In at least one embodiment, the one or more verified properties of the composite TEE 150 may include any combination of these properties.

In at least one embodiment, the system 100 may support multiple independent secure communication channels. For example, there may be more than one application (e.g., in the same or a different VM 116) using the GPU(s) 104 concurrently. Each application may need to communicate with the GPU 104 (and/or instance thereof) independently so that one application does not impact another.

In one or more embodiments, independent secure communication channels may be provided using a unique key per channel, with each channel managing a respective IV space. To reduce key storage, all user mode applications within a VM 116 and/or associated with a same user may share the same key.

In at least one embodiment, each channel(s) allocated to an application 108 (e.g., a user mode driver 122) may receive at least one unique channel counter or tracker. The user mode driver 122 may increment the message counter for encryption and may request for a new channel(s) (and/or at least one new IV) to prevent message counter overflow, as described herein. A kernel mode driver 122 may manage the channel counter(s) and increment for each channel allocation. A unique channel counter(s) combined with incrementing the message counters may allow the channels to operate independently while preventing key, IV pair reuse.

To prevent key, IV pair reuse, the IV may be split into multiple (e.g., two) parts. As an example, splitting an IV into two parts for a key may allow for 2\hat{ }64 independent channels to be created, with each channel being able to send up to 2\hat{ }32 messages. In at least one embodiment, once all the channels for a key have been used, the key may be changed. Key rotation may involve each user mode driver 122 and/or application 108 coordinating with the kernel mode driver 122 to switch to a new key.

In at least one embodiment, an application 108 performing the encryption may send a set of the cipher data, the authentication tag, and the IV to the end point that is to decrypt and consume the data. The end point may use the provided inputs to decrypt, authenticate, and consume the data. To present an adversary or malicious entity from reusing the data for a replay attack, the IV to use for encryption and its corresponding decryption may be tracked at both ends of the secure communication channel(s). Rather than the end point performing the decryption using the IV sent by the encrypting application 108, the end point may use a version of the IV maintained and/or generated at the end point. For example, similar to incrementing the IV after encryption, the end point may increment a local IV after decryption. Thus, if an adversary or malicious entity attempts a replay attack, the decryption authentication will fail, as the local IV has already changed.

In at least one embodiment, one or more of the secure channels may be used by the VM 116 to receive one or more attestation reports from the GPU(s) 104. In at least one embodiment, the secure processor 146 generates one or more of the attestation reports indicating the GPU(s) 104 is operating within a secure execution mode and/or a confidential compute mode. For example, the secure processor 146 may obtain data associated with the GPU 104 and sign the data with the private key(s) stored within the GPU 104. In one or more embodiments, the secure processor 146 generates information useable by the CPU TEE 170 or entity thereof to authenticate the GPU 104 (e.g., using the attestation manager 140) and ensure the security properties for the CPU TEE 170 when adding the GPU 104 to the CPU TEE 170 to form the composite TEE 150. In at least one embodiment, a service provider (e.g., a computing resource service provider providing the computing resources to execute the CPU TEE 170) and/or manufacturer of the GPU 104 provides additional information for authenticating and/or attesting to the GPU 104. For example, the service provider may provide a list of GPUs that are connected to a server executing the CPU TEE 170.

As described herein, the cryptographic material (e.g., a public and private key associated with the GPU 104) may be stored in a read only memory device such as a fuse block within the GPU 236, which may correspond to the key fuse(s) 138. In various embodiments, the cryptographic material is written to secure write-once memory (e.g., a fuse block) such that the data cannot be rewritten or otherwise modified once written to the secure write-once memory. In one or more embodiments, the cryptographic material is stored within the GPU 104 such that the public key(s) is accessible to various components of the server (e.g., the CPU), but the private key(s) 178 is only accessible to the secure processor 146. In such examples, access to the private key(s) associated with the GPU 104 may be blocked for all entities except for the secure processor 146 of the GPU 104.

In at least one embodiment, the application 108 runs as an application instance in the VM 116. In one or more embodiments, the host OS 114 may include a window manager used to control the placement and/or appearance of windows. For example, the host OS 114 may launch the VM 116, causing the hypervisor 118 to assign one or more of the interfaces 124 (e.g., physical and/or virtual interfaces) to the VM 116 and/or causing the application 108 to be run and presented (e.g., responsive to launching the VM 116) in a windowed, full screen, or background mode. In at least one embodiment, the VM 116 may be launched responsive to one or more user inputs to an input device. In at least one embodiment, the VM 116 may comprise a trimmed down and/or lightweight operating environment, such as Windows Sandbox. In at least one embodiment, the operating environment may load each time in a same state. For example, data may not persist between launches of the VM 116 and the VM 116 may be loaded from immutable state data. In one or more embodiments, the VM 116 may correspond to immutable and mutable state data. For example, virtualization components may correspond to immutable state data. Mutable state data for the VM 116 may include save files, temporary files, etc. The operating environment may use hardware-based virtualization for kernel isolation with an integrated kernel scheduler and memory manager.

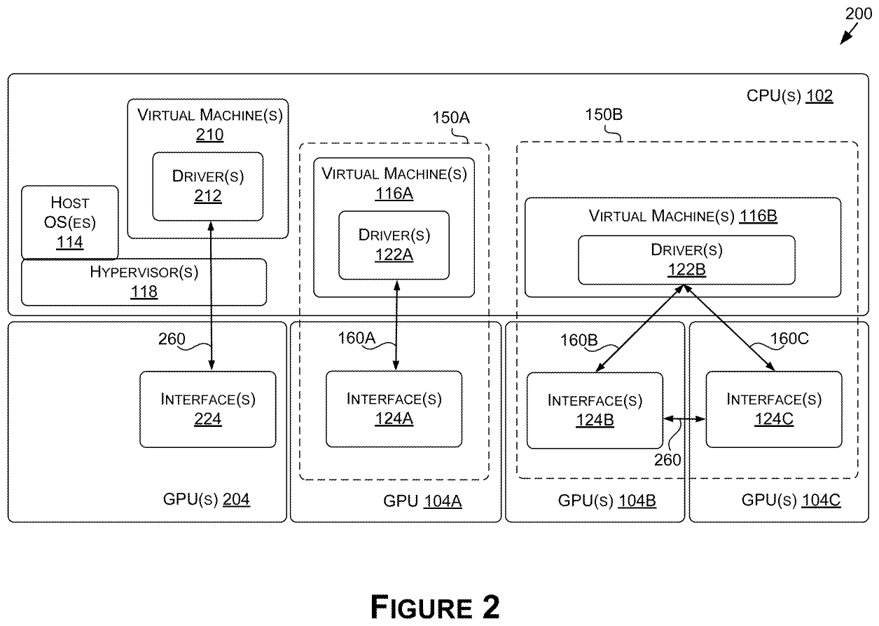

Referring now to FIG. 2, FIG. 2 depicts examples of configurations in a multi-PPU system 200, in accordance with at least some embodiments of the present disclosure. In the example of FIG. 2, the CPU(s) 102 may be used to implement multiple VMs, any of which may use one or more PPUs for hardware acceleration. The PPUs may include, for example, a GPU(s) 104A, a GPU(s) 104B, and/or a GPU(s) 104C, any of which may correspond to the GPU(s) 104 of FIG. 1. The PPUs of the system 200 may include, for example, a GPU(s) 204, which may or may not correspond to the GPU(s) 104 of FIG. 1. In at least one embodiment, FIG. 2 may correspond to a multi-GPU server. Some of the GPUs may run in a non-confidential compute mode, while others may run in a confidential compute mode (e.g., in a single GPU configuration or a multi-GPU configuration).

In at least one embodiment, a GPU 104 or group of GPUs 104 are exclusively assigned to a VM 116(s). In one or more embodiments, GPU processing kernels and user mode drivers (e.g., corresponding to a driver(s) 122) may run as a GPU passthrough guest without involvement of the hypervisor 118 after the GPU passthrough is established. Data over the interface(s) 124 may be encrypted using secure sessions established between the VMs 116 and the GPUs 104, as described herein. In one or more embodiments, the hypervisor 118, and/or the host OS 114 may be limited to a reduced subset of managerial access to the GPU(s) 104 via out of band (OOB) interfaces.

A TEE 150A, which may correspond to a TEE(s) 150 of FIG. 1, includes a VM 116A, which may correspond to the VM(s) 116 of FIG. 1, and may use the GPU 104A for hardware acceleration within the composite TEE 150A. For example, a driver(s) 122A, which may correspond to a driver(s) 122 of FIG. 1, a communication channel(s) 160A, which may correspond to a communication channel(s) 160 of FIG. 1, and an interface 124A, which may correspond to an interface(s) 124 of FIG. 1, may be used to implement hardware acceleration using the GPU 104A.

A TEE 150B, which may correspond to a TEE(s) 150 of FIG. 1, includes a VM 116B, which may correspond to the VM(s) 116 of FIG. 1, and may use the GPU(s) 104B and the GPU(s) 104C for hardware acceleration within the composite TEE 150B. For example, a driver(s) 122B, which may correspond to a driver(s) 122 of FIG. 1, a communication channel(s) 160B and a communication channel(s) 160C, which may correspond to a communication channel(s) 160 of FIG. 1, and an interface 124B and an interface 124C, which may correspond to an interface(s) 124 of FIG. 1, may be used to implement hardware acceleration using the GPU 104B and the GPU 104C.

In at least one embodiment, the GPU 104B and the GPU 104C may communicate with one another using the communication channel(s) 260, which may be similar to or different than the communication channel(s) 160 of FIG. 1. For example, the communication channel(s) 260 may include one or more secure communication channels for encrypted communications between the GPU 104B and the GPU 104C. In at least one embodiment, the communication channel(s) 260 may correspond to one or more direct PPU to PPU interconnects, such as NVLink interconnects.

In at least one embodiment, a VM 210 may use the GPU 204 for hardware acceleration. For example, a driver(s) 212, a communication channel(s) 260, and an interface 224, may be used to implement hardware acceleration using the GPU 204. In at least one embodiment, the hypervisor 118 may facilitate transfers over the communication channel(s) 260, which may be encrypted or unencrypted. For example, while the VM 116A and the VM 116B may use corresponding PPUs for confidential computing, the VM 210 may use the GPU 204 without confidential computing.

As described herein, in one or more embodiments, a PPU, such as a GPU 104, includes integrated memory, one or more secure microcontrollers, and a private key (e.g., a key 178) of a public-private key pair. The public key, of the public-private key pair, can be provided by a manufacturer of the PPU and can be used to authenticate the PPU and/or attest to information associated with the PPU. Furthermore, these PPUs can be included as hardware in server computer systems in data centers that provide computing resources to users over one or more networks. In such environments, optimizations can be performed by a compiler to use execution streams and computing resources of the PPUs. For example, an execution stream may include a sequence of operations that executes in order, where different execution streams are executed concurrently and can be executed out of order with respect to other execution streams. The use of these execution streams can improve performance by at least overlapping memory copies and kernel executions. In various examples, the PPUs available to a VM 116 in a multi-tenant environment performing parallel execution of multiple execution streams. Furthermore, in such examples, the execution streams may correspond to a compute unified device architecture (CUDA) execution stream or an OpenCL (Open Computing Language) execution stream.

Returning to FIG. 1, the VM 116, such as the driver(s) 122, may create a shared secret(s) 168 (e.g., one or more cryptographic keys) with the GPU 104. In at least one embodiment, the GPU 104 includes the private key(s) 178 burned into one or more fuses or otherwise stored in the device hardware (e.g., by the manufacturer). For example, the one or more fuses may correspond to the key fuse(s) 138 in FIG. 1. As described herein, a public key(s) corresponding to a private key(s) 178 may be published (e.g., by the manufacturer).

In at least one embodiment, the VM 116, such as the driver(s) 122, (e.g., via the CPU(s) 102) performs the SPDM key exchange with the GPU 104 to generate the shared secret(s) 168 (e.g., one or more cryptographic keys). In addition, the VM 116 (e.g., the driver(s) 122) may cause the user of the system 100 to obtain the public key (e.g., request the public key from the GPU 104 or other entity such as a server operated by the manufacturer) and use the public key to generate the shared secret(s) 168 (e.g., using the Diffie-Hellman key exchange algorithm). In at least one embodiment, the shared secret(s) 168 includes a symmetric cryptographic key(s). Furthermore, in at least one embodiment, the shared secret(s) 168 is maintained in the VM 116 and the secure processor 146. As described herein, data exchanged between the CPU 102 and the GPU 104 (e.g., using a buffer 110A and/or a buffer 110B) may be encrypted or otherwise protected using the shared secret(s) 168. For example, data exchanged using the application(s) 108 may use the buffer 110A and first one or more shared secrets 168 and data exchanged using the driver(s) 122 may use the buffer 110B and second one or more shared secrets 168.

As described herein, to secure the composite TEE 150 including the GPU 104, the VM 116 and the secure processor 146 of the GPU 104 may negotiate a shared key. In such examples, the secure processor 146 may operate as the root of trust for the GPU 104 within the composite TEE 150. Furthermore, direct memory access between the CPU 102 (e.g., the VM 116) and the GPU 104 can be secured using the shared key and a bounce buffer 110A, 110B, or similar unsecure memory region to transmit data. In one or more embodiments, where data is transmitted from the VM 116 to the GPU 104, once the shared key is negotiated, the VM 116 encrypts data using the shared key and stores the encrypted data in a memory region accessible to the GPU 104. The secure processor 146 may then obtain the encrypted data, decrypt the encrypted data with the shared key, and store the results in the protected memory region of the GPU 104. Similarly, in examples where data is transmitted from the GPU 104 to the VM 116, the secure processor 146 may encrypt data from the protected memory region of the GPU 104 and store the data in a memory region accessible to the CPU 102. The VM 116 may then obtain the encrypted data, decrypt the encrypted data with the shared key, and store the decrypted data (e.g., data in plain text form) within the CPU TEE 170.

Referring now to FIG. 3, FIG. 3 depicts an example of a system 300 including a TEE having a PPU, in accordance with at least some embodiments of the present disclosure. The system 300 may correspond to the system 100 of FIG. 1. In at least one embodiment, the system 300 is included in a data center and used to provide computing resources to users of a computing resource service provider, such as a GPU tenant(s) 322.

The memory 342 (e.g., CPU memory) may include various types of memory, such as volatile or non-volatile memory. In at least one embodiment, the memory 342 includes semiconductor memory or separate hardware such as random-access memory (RAM).

In at least one embodiment, the CPU(s) 102 is used to implement the CPU TEE 170 within which a user(s) can execute various applications such as the application(s) 108 running on the VM(s) 116. As described herein, the VM 116 may be encrypted and secured using an encryption technique such as secure encrypted virtualization (SEV). In at least one embodiment, cryptographic material (e.g., one or more cryptographic keys) is used to encrypt the CPU TEE 170 and data within a secure region(s) 316 of memory 342 (e.g., system memory). Data not encrypted with the cryptographic material may be stored in an unsecure region(s) 318 of the memory 342. In one or more embodiments, the data in the unsecure region 318 may be accessible to the hypervisor 118 and/or other untrusted components of the system 300. In one or more embodiments, the cryptographic key(s) may be used to isolate the guest OS(es) 120 and/or other components of the VM 116 from the hypervisor 118. In at least one embodiment, the cryptographic key(s) is managed by the CPU(s) 102 and not exposed or otherwise accessible to the hypervisor 118.

At least some memory transfers in the system 300 may be implemented using a system bus(es) 320. In at least one embodiment, the system bus 320 includes computer hardware that connects or otherwise provides one or more communication channels between components of the system, such as those described with respect to FIG. 1. For example, the system bus(es) 320 may correspond to one or more of the interface(s) 124 of FIG. 1. In one or more embodiments, the system bus 320 includes at least one PCIe bus.

In at least one embodiment, to include a GPU 104 in a TEE 150 of FIG. 1 (e.g., to allow the VM 116 to access the GPU 104), the GPU 104 may be placed in a secure mode (e.g., an enclave mode and/or a confidential compute mode). In one or more embodiments, the GPU 104 may be required to reset in order to switch the GPU 104 from non-secure to secure mode, or from secure mode to non-secure mode. For example, the system 100 may block access to the GPU 104 to allow the GPU 104 to be reset to enter the secure mode. In one or more embodiments, the secure processor(s) 146 blocks or otherwise prevents the access to the GPU 104. The secure processor 146 may be and/or include one or more microcontrollers including microcode and may be integrated into the GPU(s) 104. In one or more embodiments, the secure processor 146 initializes the GPU(s) 104 in the secure mode. For example, the secure processor 146 may create or cause to be created a protected region(s) 336 of the memory 334 and/or a GPU trust boundary 326. In one or more embodiments, the GPU trust boundary 326 includes a logical representation of secure components (e.g., data protected with the cryptographic key(s), components protected from unauthorized access, etc.) included in the GPU(s) 104.

In one or more embodiments, the protected memory region 336 includes a majority of the GPU 104 memory, leaving a smaller portion of the memory 334 unprotected (an unprotected region(s) 332). By way of example, and not limitation, ninety five percent of the GPU 104 memory may be initialized as the protected memory region 336 when the GPU 104 enters the secure mode. In at least one embodiment, the remaining five percent of the memory 334 may remain unprotected. In various embodiments, the protected memory region 336 is used to store model weights for machine learning algorithms, results of inferencing, source data, user data, and/or any other data to be protected. In various embodiments, the unprotected memory region 332 is used to store encrypted GPU state data, such as CUDA kernels, command buffers or bounce buffers for GPU-to-GPU communication across NVLINK or another type of device-to-device interconnect.

In one or more embodiments, the memory 334 is used to store internal data structures, semaphores, and/or other data used by the system 300 to perform any of the various operations described in the present disclosure. Furthermore, in various embodiments, the driver(s) 122 include executable code that, as a result of being executed (e.g., by a virtual processor within the CPU TEE 170), causes data to be stored in the protected memory region 336 of the GPU 104. For example, as a result of the application 108 calling a particular function of the driver(s) 122, encrypted data may be transferred using a buffer 310 across the system bus 320 to the secure processor 146, decrypted, and stored in the protected region(s) 336. The buffer 310 in in FIG. 3 may correspond to one or more of the buffer(s) 110A or the buffer(s) 110B of FIG. 1.

In the example shown, the system bus 320 includes a virtual bus(es) 338. In one or more embodiments, the virtual bus 338 includes a PF of the system bus 320. In one or more embodiments, the PF may correspond to a function of a GPU that supports a single root I/O virtualization (SR-IOV) interface. In at least one embodiment, the PF includes the SR-IOV Extended Capability in the PCIe Configuration space which is used to configure and manage the SR-IOV functionality of the GPU 104, such as enabling virtualization and exposing PCIe Virtual Functions (VFs). In at least one embodiment, the PF is exposed as a virtual GPU in the management operating system of the hypervisor parent partition.

In one or more embodiments, the memory accessor 130 includes one or more of the copy engines described herein and/or implemented functionality described with respect to the copy engine(s). The memory accessor 130 includes a hardware block of the GPU 104 that manages the protected region(s) 336. For example, the memory accessor 130 may operate with a memory management unit (MMU) of the GPU 104 to control access to the protected region(s) 336. In at least one embodiment, the memory accessor 130 manages access to the protected region(s) 336 such that once a compute engine (e.g., the compute engine(s) 128) accesses the protected region(s) 336 (e.g., writes and/or reads from a memory region associated with the protected region(s) 336), the compute engine is unable to access and/or is prevented from accessing any other memory regions outside of the protected region(s) 336, such as the memory 342 or other portions of the memory 334. For example, once a particular compute engine 128 has access to the protected region(s) 336, the memory accessor 130 and/or the memory management unit may evaluate memory requests from the particular compute engine 128 and output a fault if the compute engine 128 attempts to access memory outside of the protected region(s) 336. In at least one embodiment, the memory accessor 130 is responsible for effectuating direct memory access (DMA) of the memory 334.

In at least one embodiment, the memory accessor 130 includes one or more copy engines for implementing the GPU TEE 172. As with other engines described herein, particular types of engines are provided as examples, and embodiments may include hardware and/or software engines. The copy engine(s) may use one or more logical copy engines (LCEs) and physical copy engines (PCEs) that are capable of AES. The LCEs and PCEs may be implemented using hardware blocks of the GPU 104. The PCEs may perform data movement and the LCEs may implement control logic to manage the PCEs. The copy engine(s) may be configured to fetch and decrypt data into the protected region(s) 336, encrypt and sign transfers from the memory 334 to the memory 342 using the bounce buffer 310, decrypt data from the VM 116 into the memory 334, encrypt and sign transfers from the memory 334 to other PPU memory to encrypt to a GPU memory bounce buffer outside of the protected region(s) 336, encrypt GPU push buffers and CUDA kernels sent to the GPU 104, which are then decrypted by the copy engine before being executed, and/or decrypt GPU synchronization signals sent from the GPU 104.

In at least one embodiment, the memory accessor 130 uses one or more sets of keys (e.g., stored in key slots of an LCE), where a set has a key(s) for encryption and a key(s) for decryption. In at least one embodiment, a set of keys may be used for transfers with kernel mode clients, such as a kernel mode driver 122. In at least one embodiment, another set of keys may be used for transfers with user mode clients, such as a user mode driver(s) 122. In at least one embodiment, another set of keys may be used for transfers with other PPUs in multi-GPU configurations.

When copying data (e.g., data stored in the secure region(s) 316) the VM 116 (e.g., the driver(s) 122) may cause the system 300 to obtain the data from the secure region(s) 316, encrypt the data with the shared secret 168, and store the encrypted data in the buffer(s) 310. In various embodiments, the buffer 310 includes the unsecure region 318. For example, the buffer 310 may include at least one memory region accessible to the secure processor 146 through the system bus 320 and/or a component thereof.

In at least one embodiment, data in the secure region(s) 316 is encrypted and/or protected from access by untrusted entities associated with the CPU(s) 102 (e.g., the hypervisor 118 and the host OS 114). Thus, the driver(s) 122 and/or other components within the CPU TEE 170 may encrypt or otherwise protect the data prior to the data being transmitted outside the CPU TEE 170 (e.g., across the system bus 320 using the buffer 310). Once the CPU TEE 170 encrypts the data and stores the encrypted data in the buffer 310, the memory accessor 130 may obtain the encrypted data (e.g., may copy the encrypted data over the system bus 320), decrypt the data using the shared secret 168, and store the plain text data in the protected region(s) 336. As the data transmitted across the system bus 320 is encrypted it may be protected from attacks, such as interposer attacks.

Similarly, when transmitting data from the protected region(s) 336 of the GPU(s) 104 to the CPU TEE 170, in various embodiments, the memory accessor 130 encrypts the data to generate encrypted data and copies the encrypted data (e.g., transmits the data across the system bus 320), using the buffer 310, to the unsecure region 318 of the memory 342. In response, the CPU TEE 170 (e.g., the driver(s) 122) may obtain the encrypted data from the buffer 310 and decrypt the encrypted data using the shared key 168 such that the data is in plain text and accessible to one or more components within the CPU TEE 170.

In one or more embodiments, the memory accessor 130 and/or other components of the GPU(s) 104 (such as the memory management unit) prevents access by the CPU(s) 102, other GPUs or devices connected to the GPU(s) 104, and/or one or more components thereof to the protected region(s) 336 (e.g., corresponding to the secure region(s) 420 of FIG. 4). In contrast, in at least one embodiment, the CPU(s) 102, other GPUs or devices connected to the GPU(s) 104, and/or one or more components thereof may be capable of accessing one or more unprotected regions of the memory 334 (e.g., corresponding to the unsecure region(s) 414 of FIG. 4). In at least one embodiment, the CPU(s) 102 and/or the CPU TEE 170 (e.g., the driver(s) 122) copy encrypted data (e.g., executable code, kernels, data structures, etc.) to the unprotected or unsecured regions of the memory 334, examples of which are provided in relation to FIG. 4.

Referring now to FIG. 4, FIG. 4 illustrates an example of copy operations within a TEE having a PPU, in accordance with at least some embodiments of the present disclosure. In at least one embodiment, data is copied from a GPU memory 404 (e.g., corresponding to the memory 334) to a CPU memory 402 (e.g., corresponding to the memory 344) in a CPU TEE, such as the CPU TEE 170. In one or more embodiments, the GPU memory 404 is used by the GPU(s) 104 to store data used by the GPU(s) 104 during execution of source code or other executable instructions. For example, the GPU memory 404 may be integrated with the GPU(s) 104 operating in a secure execution mode (e.g., enclave mode). In various embodiments, the GPU memory 404 includes an unsecure region(s) 414 and a secure region 420. The unsecure region 414 may be accessible to the CPU 102 or other hardware accelerator. The secure region 420 may be inaccessible to the CPU 102 or other accelerator or otherwise protected (e.g., may correspond to CPR memory).

In one or more embodiments, one or more methods are used to secure the secure region 420 of the GPU memory 404. In at least one embodiment, access to the secure region 420 of the GPU memory 404 may be limited such that once the compute engine 128 accesses the secure region 420 of the GPU memory 404, the compute engine 128 is blocked from writing data outside the secure region 420 of the GPU memory 404. In at least one embodiment, read and write access to the secure region 420 of the GPU memory 404 by one or more other devices (e.g., CPUs, GPUs, and/or PPUs) may be blocked or otherwise prevented (e.g., using one or more hardware firewalls, as described herein). For example, as described herein, an MMU of the GPU 104 may prevent access to the secure region 420 of the GPU memory 404 based at least on preventing access from across the system bus 320. In such examples, the MMU may prevent access to the secure region 420 of the GPU memory 404 based at least on a hardware identifier or other identifier of the entity attempting to access the secure region 420 of the GPU memory 404. In one or more embodiments, the MMU returns a fault or other error if an unauthorized entity attempts to access the secure region 420 of the GPU memory 404. In at least one embodiment, unauthorized entities include any entity that is not the secure processor 146, the memory accessor 130, and/or a particular compute engine 128 that has access to the secure region 420 of the GPU memory 404. If the particular compute engine 128 attempts to access a memory range(s) that is not within the secure region 420 of the GPU memory 404, the memory management unit may issue a fault(s) and block the access.

In one or more embodiments, memory copies, such as a memory copy 438, between the secure region 420 of the GPU memory 404 and the CPU memory 402 and/or other system memory are encrypted and transmitted across a bus (e.g., the system bus 320) through a bounce buffer (e.g., the encrypted results 410). In at least one embodiment, the memory copy 438 may include data from an output buffer 426 within the secure region 420 of the GPU memory 404 after being encrypted by the memory accessor 130. As described herein, in various embodiments, an entity (e.g., driver(s), application(s), guest operating system(s), etc.) within the CPU TEE 170 (not shown in FIG. 4 for simplicity) obtains the encrypted results 410 from an unsecure region(s) 406 of the CPU memory 402, decrypts the encrypted results 410, and copies the results 412 (e.g., the data in plain text form) into a secure region(s) 408 of the CPU memory 402. In at least one embodiment, the secure region 408 of the CPU memory 402 includes one or more memory ranges within which data is encrypted prior to being stored within the memory range(s).

In at least one embodiment, the unsecure region 414 of the GPU memory 404 includes an encrypted driver data structure(s) 416 and an encrypted kernel(s) 418. For example, the encrypted driver data structure 416 may include data used by the driver(s) 122 to enable applications executing within the CPU TEE 170 (e.g., the application 108) to use the GPU(s) 104. The encrypted kernels 418 may include CUDA or Heterogeneous-computing Interface for Portability (HIP) kernels used during processing operations performed by the GPU(s) 104.

As described herein, in various embodiments, the memory accessor 130 generates a cryptographic key(s) used to encrypt the data in the output buffer 426 and to generate the encrypted results 410. In at least one embodiment, the compute engine(s) 128 generates the data stored in the output buffer 426. For example, the compute engine 128 may execute source code or other instructions and may place at least some of the results in the output buffer 426.

In at least one embodiment, once cryptographic material used by the GPU 104 to encrypt data to generate the encrypted results 410 (e.g., the cryptographic key(s) described herein) is generated, only the secure processor 146 and/or the memory accessor 130 has access. For example, a memory management unit of the GPU 104 may prevent access to a memory region(s) where the cryptographic key(s) is stored to any entity that is not the secure processor 146 and/or the memory accessor 130. In at least one embodiment, the secure processor 146 includes memory that is only accessible to the secure processor 146. Furthermore, in various embodiments, the secure processor 146 may manage placing the GPU 104 in the secure execution mode and/or the confidential compute mode, where generating the shared cryptographic key may be part of the process for incorporating the GPU 104 into the composite TEE 150.

Referring now to FIG. 5, FIG. 5 illustrates an example of copy operations within a TEE having a PPU, in accordance with at least some embodiments of the present disclosure. In at least one embodiment, memory copies, such as a memory copy 538 between the secure region 408 of the CPU memory 402 and the GPU memory 404 are encrypted and transmitted across a bus (e.g., the system bus 320 of FIG. 3) through a bounce buffer (e.g., a bounce buffer 310 of FIG. 3).

In the example of FIG. 5, the memory copy 538 includes encrypted user data 542 corresponding to user data 422 from the secure region 408 of the CPU memory 402 and an entity within the CPU TEE 170 (e.g., the VM 116 or component thereof). The user data 422 may be for a machine learning algorithm(s) or other artificial intelligence (AI). However, the user data 422 may more generally correspond to any data which may be transferred between the CPU memory 402 and the GPU memory 404.

As described herein, in various embodiments, an entity (e.g., a driver(s), an application(s), a guest operating system(s), etc.) within the CPU TEE 170 (not shown in FIG. 5 for simplicity) encrypts the user data 422 obtained from the secure region 408 of the CPU memory 402 and stores the encrypted user data 542 in the unsecure region 406 of the CPU memory 402 (e.g., an unencrypted memory region accessible to the GPU 104). Further, in various embodiments, the unsecure region 406 of the CPU memory 402 includes the bounce buffer 310 for transmitting data across the system bus 320 between the CPU TEE 170 and the GPU 104.

In FIG. 5, the unsecure region 406 of the CPU memory 402 includes a driver data structure 516 corresponding to the encrypted driver data structure 416 and the kernel 518 corresponding to the encrypted kernel 418. The data structure 516 (e.g., a driver data structure) may include data used by the compute engine 128 to perform inferencing using the user data 422. More generally, the data structure 516 may include data used by the compute engine 128 to perform one or more parallel processing operations using data from the CPU memory 402, such as the user data 422. The kernels 518 may be used during the parallel processing operations performed by the compute engine 128 of the GPU 104. In at least one embodiment, the data structure 516 and the kernel 518 are encrypted, then transmitted across the system bus 320 to the GPU memory 404 as the encrypted data structure 416 and the encrypted kernel 418.

In various embodiments, the secure processor 146 and/or the memory accessor 130 obtains the encrypted user data 542 from the unsecure region 406 of the CPU memory 402 and performs, at least partially, the memory copy 538 based at least on copying the encrypted user data 542 across the system bus 320, decrypting the encrypted user data 542, and storing the result (e.g., the user data 422 in plain text) in the secure region 420 of the GPU memory 404.

In at least one embodiment, one or more requests may be made to enable the GPU 104 to operate within the composite TEE 150 and/or the GPU TEE 172. In at least one embodiment, the one or more requests are made using the platform manager 152. In at least one embodiment, the platform manager 152 includes a baseboard management controller (BMC) that issues the one or more requests. In at least one embodiment, the one or more requests are to persistently enable a confidential compute mode of the GPU 104.

In various embodiments, in order for the GPU 104 to be included in the composite TEE 150, the GPU 104 may be operating in a secure execution mode (e.g., an enclave mode and/or a confidential compute mode), as described herein. For example, the secure execution mode of the GPU 104 may enable various data protection features of the GPU 104 based at least on limiting and/or blocking access to one or more memory ranges and/or regions of GPU memory (e.g., the memory 334). In at least one embodiment, the compute engine(s) 128 that accesses a protected memory range or region of the GPU memory is prevented from writing to any other memory range or region. In at least one embodiment, a memory management unit of the GPU 104 prevents access to the protected memory ranges or regions of the GPU 104 from one or more entities (e.g., CPU or other accelerators) via the system bus 320.

In at least one embodiment, to enable a confidential compute mode, one or more components of the system 100 writes data to non-volatile memory of the GPU 104 indicating that, on reset, the GPU 104 is to enter the confidential compute mode.

In at least one embodiment, one or more components of the system 100, causes the GPU 104 to be reset. In at least one embodiment, the reset is triggered by the host OS 114 and/or the hypervisor 118, for example over the communication channel 162. In at least one embodiment, the triggering may include a function level reset (FLR), such as a PF-FLR.

The reset of the GPU 104 may initiate operations to place the GPU 104 in the confidential compute mode (or more generally to instantiate and/or configure the GPU TEE 172) and pass the GPU 104 to the CPU TEE 170. On reset, the memory of the GPU 104 may be scrubbed (e.g., by the secure processor 146 and/or GPU firmware) before the memory is made visible on the system bus 320.

In one or more embodiments, once the GPU 104 has been reset, the GPU 104 may implement, enable, and/or configure the protected region(s) 336. In at least one embodiment, the secure processor 146 of the GPU 104 causes the protected region(s) 336 to be implemented, enabled, and/or configured. In one or more embodiments, the protected region(s) 336 is managed by a memory management unit such that, for example, the compute engine 128 of the GPU 104 is allowed to access the protected region(s) 336, but is unable to (e.g., blocked from) write to other memory regions at least after accessing the protected region(s) 336.

In at least one embodiment, implementing, enabling, and/or configuring the protected region(s) 336 may include implementing, enabling, and/or configuring one or more compute protected regions of memory. For example, the memory management unit may prevent particular entities from reading data from or writing data to the protected region(s) 336. In at least one embodiment, any reads or writes to the one or more protected memory regions across the system bus 320 may be blocked.

In at least one embodiment, the protected region(s) 336 may be implemented using one or more firewalls, as described herein. In at least one embodiment, based at least on the firewall(s) being enabled, the secure processor 146 and/or GPU firmware enables the interface(s) 124. In at least one embodiment, the one or more firewalls may be configured to block (e.g., using the memory management unit) unauthorized accesses from outside the GPU 104, block code or data from escaping the GPU TEE 172 boundary, and/or isolate multiple tenants each into their own GPU TEE 172.

In at least one embodiment, the GPU 104 blocks (e.g., using the one or more firewalls) paths of the interface(s) 124 from access to GPU memory corresponding to the cache(s) 134 and/or the RAM(s) 136 (e.g., the memory 334 of FIG. 3). Blocking the access may protect the GPU memory from the CPU 102 and other devices with access to the interface(s) 124. Additionally, the GPU 104 may raise a hardware firewall(s) preventing software executing in the GPU TEE 172 from executing outside of the GPU TEE 172. For example, GPU engines, such as the compute engine(s) 128 may be prevented from writing unencrypted outside of the protected memory region of the GPU memory.

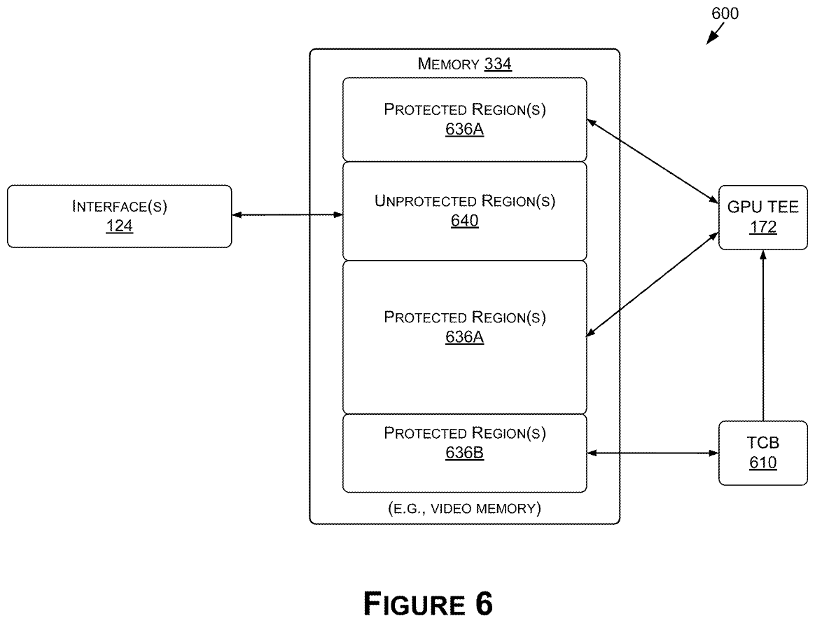

Referring now to FIG. 6, FIG. 6 illustrates an example of a memory layout 600 for blocking interfaces from accessing GPU memory within a TEE having a PPU, in accordance with at least some embodiments of the present disclosure. In one or more embodiments, external interfaces, such as the interface(s) 124 targeting a frame buffer(s) of the GPU 104 may be blocked from accessing portions of memory that belongs to the composite TEE 150 and a TCB 610 corresponding to the composite TEE 150. Examples of the external interfaces include PPU to PPU interfaces (e.g., NVLink), chip-to-chip (C2C) interfaces, memory mapping interfaces (e.g., PCIE base address register (BAR)1 and/or BAR2), and/or PPU instance RAM interfaces (e.g., PRAMIN). Examples of the portions of memory include protected region(s) 636A and 636B, which may also be referred to as protected regions 636. In at least one embodiment, the protected regions 636 correspond to the protected region(s) 336 of FIG. 3.

In at least one embodiment, the TCB 610 refers to hardware, software, and/or firmware that creates, maintains, and/or securely destroys the GPU TEE 172. By way of example, and not limitation, the TCB 610 may include one or more microcontrollers of the GPU 104, the memory accessor 130 (e.g., copy engines and/or encryption hardware), the secure processor 146, one or more portions of framebuffer and/or GPU memory, a memory management unit(s) of the GPU(s) 104, a Basic Input/Output System (BIOS), such as a video BIOS (VBIOS) of the GPU(s) 104, and/or the system processor(s) 144.

In at least one embodiment, entities in the TCB 610 may have full access to data of the GPU TEE 172, and in at least one embodiment, the entire GPU(s) 104 and/or access to data of one or more device instances. In FIG. 6, the protected region(s) 636A may correspond to the data of the GPU TEE 172. In one or more embodiments, a protected region(s) 636A belonging to the GPU TEE 172 may be referred to as a compute protected region (CPR). In at least one embodiment, entities in a GPU TEE 172 may be restricted to accessing the data within the boundary of the GPU TEE 172 and may not be able to access either data of the TCB 610 or resources associated with untrusted entities (e.g., the interface(s) 124, unsecure and/or unprotected regions of the memory 334, etc.). In FIG. 6, the protected region(s) 636B may correspond to the data of the TCB 610. In one or more embodiments, a protected region(s) 636B belonging to the TCB 610 may be referred to as an access controlled region (ACR). In at least one embodiment, the protected region(s) 636B includes the CPR(s) described herein.

In at least one embodiment, one or more portions of the memory 334 that are not under protection may be referred to as unprotected regions (UPR) or non-CPR, an example of which includes an unprotected region(s) 640. In at least one embodiment, none of the external interfaces—corresponding to the interface(s) 124—have access to CPR and ACR, but are allowed to access non-CPR, such as the unprotected region(s) 640. For example, the unprotected region(s) 640 may be accessed to use video memory-based bounce buffers, such as for a multi-GPU configuration.

In one or more embodiments, at least some software running inside the GPU TEE 172, which may include authenticated firmware and GPU processing kernels (e.g., sourced from the CPU TEE 170), only has access to CPR memory and protected registers. So that any bugs in the software cannot be exploited to leak data outside this boundary, the one or more hardware firewalls may block access to non-CPR and unprotected registers to prevent leakage due to bugs. For example, the GPU engines may be blocked from accessing non-CPR memory. For transferring data in and out of the GPU TEE 172, the memory accessor 130 may have encryption/decryption support to transfer encrypted data between the GPU TEE 172 and the CPU TEE 170 (e.g., as described with respect to FIGS. 3-5).

In at least one embodiment, copy engines, corresponding to the memory accessor 130, are part of the GPU TEE 172 are allowed to transfer data between CPR & Non-CPR regions of the memory 334 after encryption and decryption. The copy engines may include hardware logic that ensures data copied from CPR to Non-CPR always gets encrypted and data copied from non-CPR to CPR always gets decrypted and compared using the authentication tag. The copy engines may also support CPR to CPR and non-CPR to non-CPR copies in plain text.

During decryption, a copy engine may compute the authentication tag for the entire buffer and compare at the very end of the last chunk of copy. In one or more embodiments, there may be insufficient room to cache the data until the complete authentication tag is available. Thus, the copy engine may decrypt and write the contents to CPR memory before the authentication tag is fully validated. If the authentication tag is found to be invalid at the end, all the contents which are already in the CPR memory is not scrubbed by copy engine. In at least one embodiment, the kernel mode driver(s) 122 and user mode driver(s) 122 ensure the invalid data in the CPR memory is not used and gets scrubbed.

During encryption, a copy engine may encrypt and write the cipher data to non-CPR memory while the authentication tag is computed in the back end. Once the authentication tag is computed at the very end of copy, the compute engine may write the authentication tag out to the address provided by the user mode driver 122

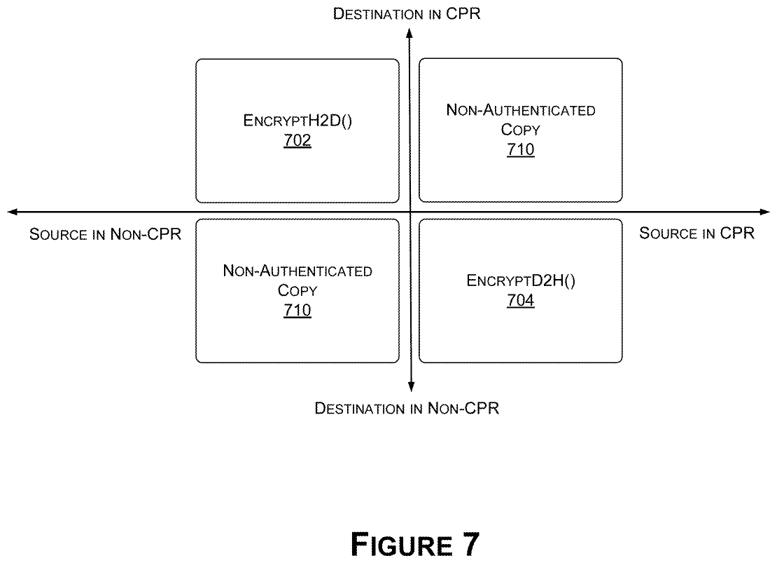

Referring now to FIG. 7, FIG. 7 illustrates an example of how a copy engine may encrypt or decrypt data based on a source or destination, in accordance with at least some embodiments of the present disclosure. EncryptH2D( ) 702 may decrypt data from non-CPR memory into CPR memory and perform a comparison using the authentication tag. EncryptD2H( ) 704 may encrypt data from CPR memory into non-CPR memory and write out a computed authentication tag. Non-authenticated copy 710 may include a plain-text copy of data.

In at least one embodiment, the copy engine(s) is used to prevent replay attacks, as described herein. In at least one embodiment, the copy engine maintains the IV for decryption and increments the IV after decryption. Thus, encryption performed using the copy engine may be configured to fail at decrypting cipher data that has already been decrypted using the copy engine. Work may be scheduled on the copy engine through host channels and each channel may have its own allocated memory in CPR memory. The kernel mode driver 122, while creating a host channel used for secure copy, may initialize the IV used for description into the channel's allocated memory. The copy engine may read the IV from the allocated memory, use the IV for decryption, increment the IV, and write the IV for subsequent decryption (e.g., back to the same location). As the copy engine may track the IV independently in allocated memory, attempts to replay cipher data may fail due to a failure in a comparison using the authentication tag.

In at least one embodiment, copy engine pre-emption may be supported with secure copies. During encryption and decryption, a copy engine (e.g., copy engine hardware) may continuously calculate the authentication tag and at the end of copy either write the authentication tag out or compare the authentication tag with the input to detect a mismatch. While pre-empting a copy, a partially calculated authentication tag may be saved and restored when the copy resumes later. Instead of creating separate channels for CPR memory to non-CPR memory and non-CPR memory to CPR memory transfers, one or more embodiments may use channels that can support both directions (bi-directional channels). This may allow for efficient usage of memory slots used for storing IVs by dedicating one slot for both directions instead of allocating two if two unidirectional channels are used instead.

In one or more embodiments, memory slots used for storing IVs are allocated by the kernel mode driver 122 when a host channel is allocated for secure copy and a slot index allocated for a channel is programmed into CPR memory (along with the IV used for decryption). During decryption or encryption, the copy engine may read the slot index from the CPR memory. The kernel mode driver 122 may ensure the same slot is not allocated to multiple channels.

In multi-GPU configurations, such as a multi-GPU configuration corresponding to the composite TEE 150B of FIG. 2 (or multi-PPU instance configurations), one GPU (e.g., the GPU 104B) may not be able to access the CPR memory of another GPU (e.g., the GPU 104C), as the interface(s) 124 between the devices may be untrusted. Instead, data may be encrypted and bounced through non-CPR memory, for example, using approaches described herein. In at least one embodiment, copy engines may be used for multi-GPU communication, and the secure processor 146 and the system processor 144 are not involved. In one or more embodiments, a copy engine in, for example, the GPU 104B encrypts contents from CPR memory and copies the encrypted data to non-CPR memory of, for example, the GPU 104C over one or more of the interfaces 124. A copy engine in the GPU 104C may decrypt the data from the non-CPR memory to CPR memory of the GPU 104C. In at least one embodiment, the copy may be coordinated by a user mode driver 122 managing peer-2-peer (P2P) communications. In one or more embodiments, a copy engine in, for example, the GPU 104B encrypts contents from CPR memory and copies the encrypted data to non-CPR memory of the same GPU. A copy engine in the GPU 104C may fetch the encrypted data from GPU 104B's non-CPR memory across the interfaces 124, decrypt the data and write it to CPR memory of the GPU 104C. In at least one embodiment, the copy may be coordinated by a user mode driver 122 managing peer-2-peer (P2P) communications.

In single-GPU configurations, such as a single-GPU configuration corresponding to the composite TEE 150A of FIG. 2, a user mode driver 122 may allocate a secure communication channel to securely communicate with the copy engine of the GPU (e.g., the GPU 104A) or the secure processor 146 of the GPU 104A. Each channel may receive a set of cryptographic information (e.g., keys, etc.) used for encryption & decryption in both directions (e.g., from a kernel mode driver 122).

In at least one embodiment, implementing, enabling, and/or configuring the protected region(s) 336 is part of a secure and/or measured boot sequence of the GPU 104, which may include configuring and/or enabling any of the properties of the GPU TEE 172 using GPU hardware and firmware. In a secure boot, at each stage of the boot process, all firmware that is loaded may be authenticated before execution, such that only signed and unrevoked code is used to boot each processor. In a measured boot, a cryptographically signed record(s) of the versions of firmware which are running on the GPU 104 may be generated into an attestation report(s) that can be requested and validated by a user and/or the VM 116 (e.g., using the attestation manager 140).

In at least one embodiment, a secure and measured boot of the GPU 104 may be implemented, at least in part, using the system processor(s) 144, such as a GPU System Processor (GSP). Examples of a GSP include a Reduced Instruction Set Computer (RISC) GSP, such as a RISC-V GSP. In at least one embodiment, the system processor 144 is used to offload one or more GPU initialization and/or management tasks of the GPU 104. In at least one embodiment, the secure and measured boot is implemented using public key confirmation (PKC) firmware authentication. In at least one embodiment, the secure and measured boot is implemented using encrypted firmware. In at least one embodiment, the secure and measured boot is implemented using firmware revocation. In at least one embodiment, the secure and measured boot is implemented using hardware and software fault injection countermeasures. In at least one embodiment, the secure and measured boot is implemented using an internal root of trust (ROT) the of GPU 104.

In at least one embodiment, booting the GPU 104 in the confidential compute mode causes the GPU 104 to protect the entire memory 334 corresponding to the GPU 104 and/or one or more portions corresponding to a GPU instance, and mark the protected memory as CPR. In one or more embodiments, the VM 116 and/or the driver 122 (e.g., a kernel mode driver 122) may determine, at boot, if non-CPR memory is needed and/or desired. If non-CPR memory is needed and/or desired, the driver 122 may carve out a contiguous region of the memory 334 that is marked as unprotected. The size of a non-CPR carve-out may be set as a percentage of total memory available for use and the total memory available for use may be pre-determined or configurable. The kernel mode driver 122 may also expose an API for the user of the VM 116 to resize the non-CPR memory. If a client allocation has been made, the client allocation may create fragmentation that could prevent the resize from being successfully completed. Thus, the resize may be permitted after boot is complete, but limited to before any client allocations are made on the GPU 104.

In at least one embodiment, the system 100 may pass the GPU 104 to the virtual machine 116. For example, the hypervisor 118 may provide the VM 116 with access to the GPU 104 using any of a variety of virtualization techniques. In various embodiments, the VM 116 and/or a component thereof (e.g., application software, guest operating system, driver, etc.) performs one or more checks to determine the GPU 104 is operating in the confidential compute mode and authenticates the GPU 104. For example, the attestation manager 140 of the VM 116 may use the attestation service 112 to authenticate the GPU 104 (e.g., using one or more attestation reports generated using the GPU 104).

In at least one embodiment, one or more secure communication channels 160 may be established between the VM 116 and the GPU 104, which may include performing shared key generation operations. In various embodiments, the secure processor 146 of the GPU 104 generates a shared cryptographic key(s) 168 with the CPU TEE 170 (e.g., with the driver 122, such as a GPU PF driver). Establishing a secure communication channel may include performing a Diffie-Hellmann shared key generation so that the VM 116 and the GPU 104 each have a copy of the shared cryptographic key(s) 168 (e.g., a symmetric session key). As described herein, the shared cryptographic key(s) 168 may be used to encrypt data for transmission between the CPU 102 and GPU 104. The one or more secure communication channels may be established using the communication channel 162 (e.g., implemented using SPDM).

In at least one embodiment, the GPU 104 may provide one or more attestation reports generated using the GPU 104 (e.g., using a GPU ROT) to the VM 116 (e.g., with the driver 122, such as a GPU PF driver). For example, the one or more attestation reports may be provided using the communication channel 160 (e.g., implemented using SPDM). In at least one embodiment, at least one attestation report is generated and provided using at least one chain of trust rooted in the GPU(s) 104 (a hardware root of trust that is separate from a hardware root of trust of the CPU(s) 102).

In at least one embodiment, the attestation manager 140 receives one or more attestation reports generated using the CPU 102 (e.g., using a CPU ROT). The attestation manager 140 may use one or more attestation reports generated using the CPU 102 and/or the GPU 104 to verify the one or more properties for the composite TEE 150. As described herein, verification may be performed locally using the attestation service 112 (e.g., located in the VM 116) and/or remotely using the attestation service 112 (e.g., located on a remote server). In at least one embodiment, at least one attestation report is generated and provided using at least one chain of trust rooted in the CPU(s) 102 (a hardware root of trust).

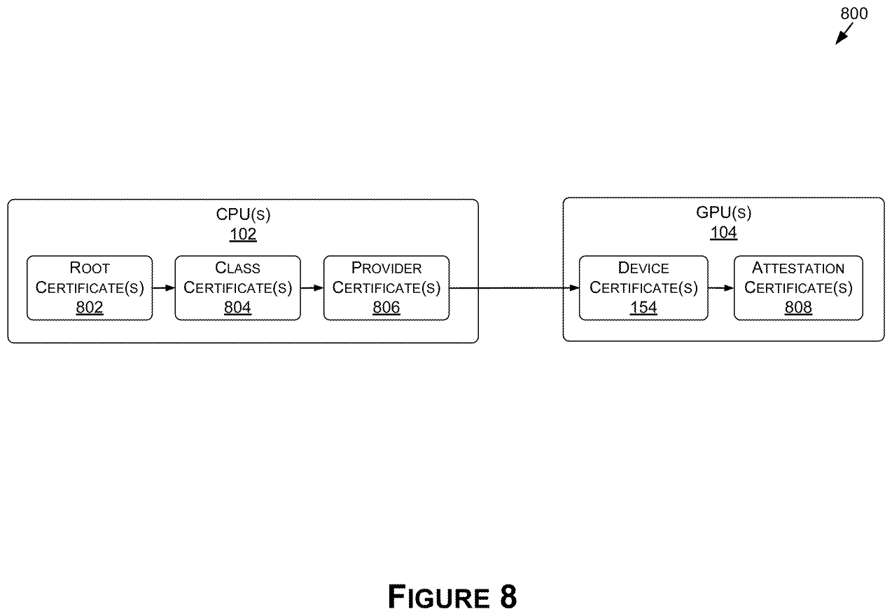

Referring now to FIG. 8, FIG. 8 illustrates an example of a certificate chain 800 which may be used to authenticate a GPU 104, in accordance with at least some embodiments of the present disclosure. In at least one embodiment, authenticating the GPU(s) 104 may include authentication that the GPU 104 is a legitimate device and is not revoked. For example, a GPU 104 may be revoked if there is a leaked private key, it the GPU 104 is determined or detected to be physically tampered with, etc.

In at least one embodiment, authentication of the GPU 104 may use public key infrastructure (PKI) authentication. In one or more embodiments, the certificate chain 800 includes multiple levels, examples which include a root certificate 802, a class certificate(s) 804, a provider certificate(s) 806, the device certificate(s) 154, and attestation certificate(s) 808. In at least one embodiment, the GPU 104 generates and/or stores the device certificate(s) 154 and the attestation certificate(s) 808. The device certificate(s) 154 may include a device unique public certificate that forms a leaf in the certificate chain 800.

In the certificate chain 800, each certificate may be signed by the entity identified by the immediate parent certificate along the certificate chain 800. A trusted leaf certificate can be traced all the way back to a root certificate 802 in the certificate chain 800. In the example shown, the GPU 104 may share the first set of levels (e.g., three levels), and therefore the first set of levels need not be stored on the GPU 104. In at least one embodiment, only the leaf certificates that come from the GPU 104 are fetched at run time (e.g., the device certificate 154 and the attestation certificate 808). The remaining certificates may be stored by the CPU 102 (e.g., cached in software, such as the driver 122).

In one or more embodiments, a kernel mode driver 122 performs the authenticating of the GPU 104 before allowing access to GPU resources. Once the GPU 104 has been fully authenticated, the kernel mode driver 122 may initiate a key exchange sequence to establish a secure session(s) with the GPU 104 (as described herein), such as using the SPDM protocol. At the end of session establishment, both the kernel mode driver 122 and the GPU 104 may include symmetric root keys used to generate transport keys for further communication.

In one or more embodiments, the kernel mode driver 122 uses the cached certificates of the certificate chain 800 to verify all the levels except the root certificate 802, which may be hard coded and not require independent authentication. The kernel mode driver 122 may verify the certificate signatures. In at least one embodiment, the kernel mode driver 122 does not check for revocation. Checking for revocation may not be required, as if the certificate revocation lists (CRLs) are cached in the kernel mode driver 122, the CRLs may go out of date. Instead, CRLs may be fetched at runtime, or services such as online certificate service protocol (OCSP) services may be used to verify the revocation status of certificates. The kernel mode driver 122, due to running in kernel mode, may not be able to communicate with external services. Thus, the task of checking for revocation may be delegated to a privileged user-mode client which after checking for revocation updates the kernel mode driver 122 with the revocation status. In one or more embodiments, the kernel mode driver 122 uses the status to either allow or block clients from using the GPU 104.

Measurements captured using an attestation report(s) may correspond to code, data, hardware and/or software state and/or configurations, fuse settings, device modes, version information, and/or orderings (e.g., of loading, launching, and/or booting one or more elements for the composite TEE 150). In one or more embodiments, the attestation report(s) provided to the attestation manager 140 and/or used by the attestation service(s) 112 to verify the composite TEE 150 may capture measurements of all software that is running in and/or is to be run in the composite TEE 150 (e.g., during an application session). The software may include firmware and/or microcode on any device used to implement the composite TEE 150. Software configurations that can impact the completeness or accuracy of the measurements may be captured in the attestation report(s) (e.g., tested mode, secure boot state). Further, hardware configurations for all devices that can impact application state may be captured in the attestation report(s).

Measurements used to generate an attestation report(s) may be generated in a deterministic manner. In one or more embodiments, attestation may include a measured boot where measurements of boot components are stored and attestation is made as to the validity of measurements by an attestor (e.g., the attestation service(s) 112). In one or more embodiments, a secure or trusted boot may be used which may include authentication of components via cryptographic verification.

In at least one embodiment, the application 108 may be executed using, at least in part, the GPU 104 based at least on transmitting data using the one or more secure communication channels 160. In at least one embodiment, the application 108 may not be allowed to start in the VM 116 and/or communicate with the GPU 104 until the one or more secure communication channels 160 are established and the properties for the composite TEE 150 are verified. Going forward, while the GPU 104 remains in the confidential compute mode, the hypervisor 118 may be prevented from reading the memory 334 and all application code and application data that crosses the system bus 320 may be encrypted.

In at least one embodiment, removing the GPU 104 from the composite TEE 150 may include one or more requests being written to disable the confidential compute mode and/or the GPU TEE 172. In one or more embodiments, the one or more requests cause the GPU 104 to exit the secure execution mode and/or the confidential compute mode at a next reset of the GPU 104. In at least one embodiment, the request(s) (e.g., data indicating an operating mode to the GPU 104) is recorded in memory of the GPU 104 (e.g., non-volatile memory, such as a PROM attached to the GPU 104).

In at least one embodiment, the system 100 resets the GPU 104 based at least on the request. For example, the secure processor 146 may cause the GPU 104 to perform a reset. After the GPU 104 is reset, the system 100 may delete, clean, and/or scrub data from GPU memory, such as the memory 334 and/or GPU state data (as described herein). In at least one embodiment, all contents of GPU memory is deleted. In at least one embodiment, the secure processor 146 and/or GPU firmware (e.g., after reset) scrubs and/or deletes the contents of the GPU memory and a GPU copy of the shared cryptographic key(s) 168 to ensure data generated within the composite TEE 150 is not exposed. In at least one embodiment, scrubbing and/or deleting the contents of the GPU memory may include deleting the contents of one or more protected region(s) 336. In at least one embodiment, scrubbing completes before the memory 334 is made visible on the system bus 320. In at least one embodiment, during the secure boot sequence of the GPU 104, all protections specific to the confidential compute mode may be disabled using the GPU hardware and firmware.

In at least one embodiment, the application 108 may be configured, launched, and executed in a TEE of GPU 104 based at least on a user selecting a Virtual Machine Image (VMI) corresponding to the VM 116. The VMI may include, for example, one or more of the drivers 122, such as a GPU driver for the GPU 104, and other components, such as other toolkits and libraries (e.g., a container toolkit, an attestation library, etc.). In at least one embodiment, the user may selectively add one or more applications, such as the application 108, to the VMI. In at least one embodiment, the user may selectively launch one or more instances of the VMI (e.g., in a cloud), such as the VM 116.

In at least one embodiment, the user may connect to the VM 116 and run the attestation manager(s) 140, CPU attestation libraries, and/or GPU attestation libraries to check whether the composite TEE 150 is established and configured correctly. In at least one embodiment, the user may launch the application 108 (e.g., the confidential application container added to the VMI). In one or more embodiments, the application 108 may use the attestation manager(s) 140, and/or call the CPU and GPU attestation libraries as part of a start-up process of the application 108.

In at least one embodiment, the application 108 pulls encrypted data into the VM 116 from network storage, or from other network locations. As the application 108 decrypts the ingested data, the data may be automatically encrypted into system memory of the VM 116 using a private key of the VM 116 (e.g., a tenant VM private key).

In at least one embodiment, the application 108 creates contexts (e.g., CUDA contexts) which send input data from system memory of the VM 116 to GPU memory of the GPU 104 (e.g., using cudaMemcpyHostToDevice( )). For example, the driver 122 may encrypt the data to the bounce buffer 110A and the memory accessor 130 may pull the encrypted data across the interface(s) 124 into GPU memory (e.g., high bandwidth memory (HBM)) in the GPU TEE 172.

In at least one embodiment, the application 108 may use the driver 122 to send encrypted kernels and commands to the GPU 104. The GPU 104 may process the kernels then execute the data in the GPU TEE 172 to generate results data. In at least one embodiment, results data in GPU memory are retrieved (e.g., using cudaMemcpyDeviceToHost( ) calls), which results in the memory accessor 130 encrypting the data before it crosses the interface(s) 124. The encrypted data may then be decrypted by the driver 122 into the system memory of the VM 116. In at least one embodiment, the decrypted results may then be application-encrypted before being sent out of the VM 116 across the network(s) 106 and/or to network storage.

In at least one embodiment, the application 108 (and/or other component corresponding to the VM 116 and/or tenant) may run attestation for the CPU TEE 170 and the GPU TEE 172 periodically during the life of the VM 116, to determine whether the attestation still indicates a confidential state. In at least one embodiment, when the application 108 exits and the user terminates the VM 116, the GPU is reset resulting in the session keys (e.g., the shared secret(s) 168) being deleted and the GPU memory and state is scrubbed prior to the GPU 104 being made available to a new tenant (e.g., as described herein).

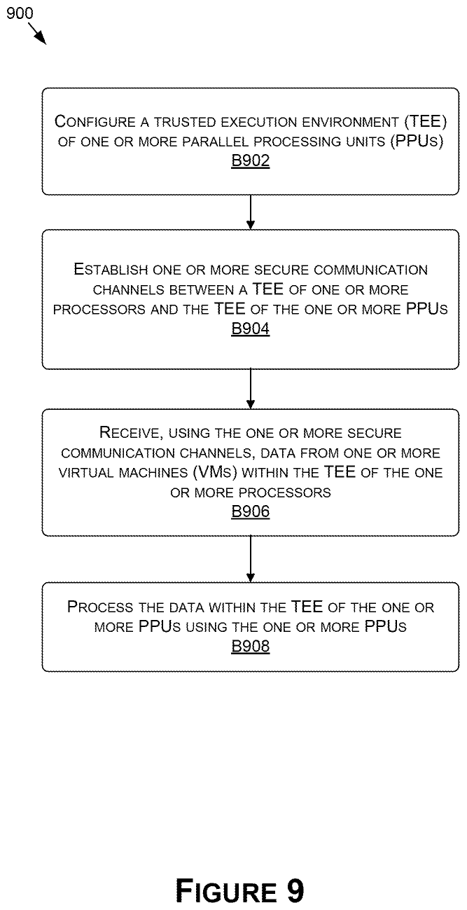

Now referring to FIGS. 9-12, each block of methods 900, 1000, 1100, 1200, and other methods described herein (e.g., the method 1600), comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

FIG. 9 is a flow diagram showing a method 900 a PPU, such as a GPU(s) 104, may use to process data within a TEE, in accordance with at least some embodiments of the present disclosure. The method 900, at block B902, includes configuring a TEE of one or more PPUs. For example, the GPU 104 may configure the GPU TEE 172 (e.g., using a secure and measured boot).

At block B904, the method 900 includes establishing one or more secure communication channels between a TEE of one or more processors and the TEE of the one or more PPUs. For example, the secure processor 146 may establish the communication channel(s) 160 between the VM(s) 116 within the CPU TEE 170 and the GPU TEE 172.

At block B906, the method 900 includes receiving, using the one or more secure communication channels, data from one or more virtual machines (VMs) within the TEE of the one or more processors. For example, the secure processor 146 may receive, using the communication channel(s) 160, data from the VM(s) 116.

At block B908, the method 900 includes processing the data within the TEE of the one or more PPUs using the one or more PPUs. For example, the compute engine(s) 128 may process the data within the GPU TEE 172.

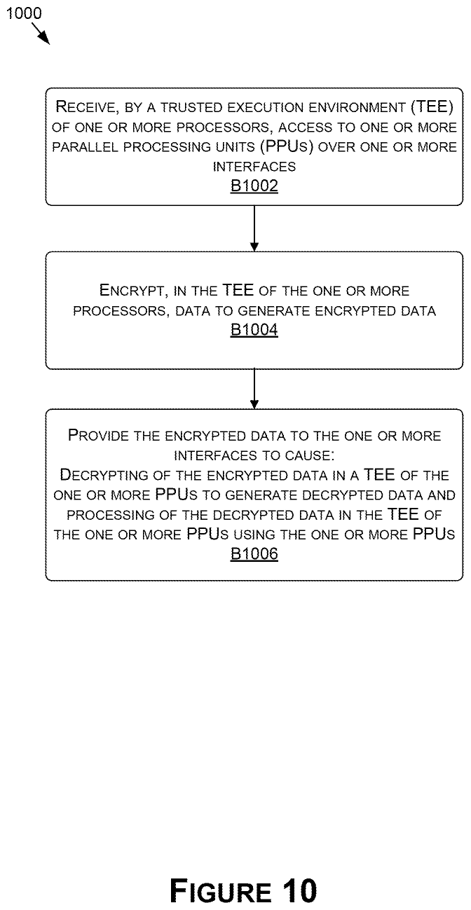

Referring now to FIG. 10, FIG. 10 is a flow diagram showing a method 1000 the CPU(s) 102 may use to process data using a PPU, such as the GPU(s) 104, within a TEE, in accordance with at least some embodiments of the present disclosure. The method 1000, at block B1002, includes receiving, by one or more virtual machines (VMs) in a trusted execution environment (TEE) of the one or more processors, access to one or more parallel processing units (PPUs) over one or more interfaces. For example, the VM(s) 116 in the CPU TEE 170 may receive access to the GPU(s) 104 over the interface(s) 124 (e.g., via the hypervisor 118).

At block B1004, the method 1000 includes encrypting, in the TEE of the one or more processors, data to generate encrypted data. For example, the VM 116 may encrypt, in the CPU TEE 170, data associated with the VM(s) 116 (e.g., generated using the application 108) to generate encrypted data.

At block B1006, the method 1000 includes providing the encrypted data to the one or more interfaces to cause decryption of the encrypted data in a TEE of the one or more PPUs to generate decrypted data and processing of the decrypted data in the TEE of the one or more PPUs using the one or more PPUs. For example, the VM 116 may provide the encrypted data over the interface(s) 124 to cause decryption of the encrypted data in the GPU TEE 172 to generate decrypted data, and to cause processing of the decrypted data in the GPU TEE 172.

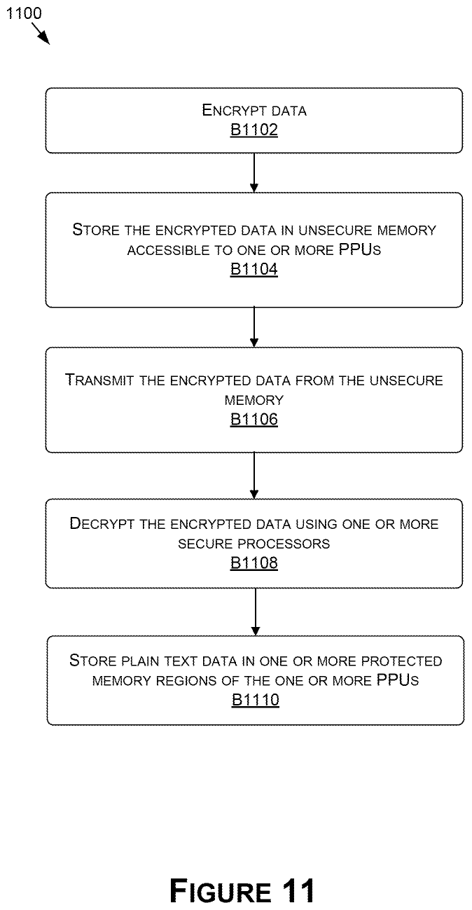

Referring now to FIG. 11, FIG. 11 is a flow diagram showing a method for copying data from CPU memory to GPU memory within a TEE that includes a PPU, in accordance with at least some embodiments of the present disclosure. The method 1100, at block B1102, includes encrypting data. In various embodiments, the application 108 executed by the VM 116 provides data to the GPU 104 for processing (e.g., inferencing, video processing, audio processing, rendering, or other operation executable by a GPU). Furthermore, in such embodiments, the secure processor 146 may negotiate a shared key with the VM 116 to encrypt data in transit between the VM 116 and the GPU 104. For example, the VM 116 (e.g., a driver(s) 122) may encrypt data to be copied to the memory 334 of the GPU 104.

At block B1104, the method 1100 includes storing the encrypted data in unsecure memory accessible to one or more PPUs. For example, the encrypted data may be stored in the bounce buffer 310 within the memory of a server executing the VM 116. In such examples, the unsecure memory may be accessible to the GPU 104 through the system bus 320, network interface, and/or other communication channel.

At block B1106, the method 1100 includes transmitting the encrypted data from the unsecure memory. For example, the system 300 may transmit the encrypted data to the memory accessor 130 of the GPU 104. In at least one embodiment, the memory accessor 130 copies the encrypted data from the unsecure memory. In at least one embodiment, the VM 116 causes the encrypted data to be copied across the system bus 320 to the memory accessor 130.

At block B1108, the method 1100 includes decrypting the encrypted data using the memory accessor 130. For example, the memory accessor 130 may maintain a copy of the shared cryptographic key and decrypt the data using the shared cryptographic key.

At block B1110, the method 1100 includes storing plain text data in one or more protected memory regions of the one or more PPUs. For example, the GPU 104, when operating in secure execution mode and/or confidential compute mode, may create the protected memory region 336, such that plain text data within the protected memory region 336 is inaccessible to unauthorized entities.

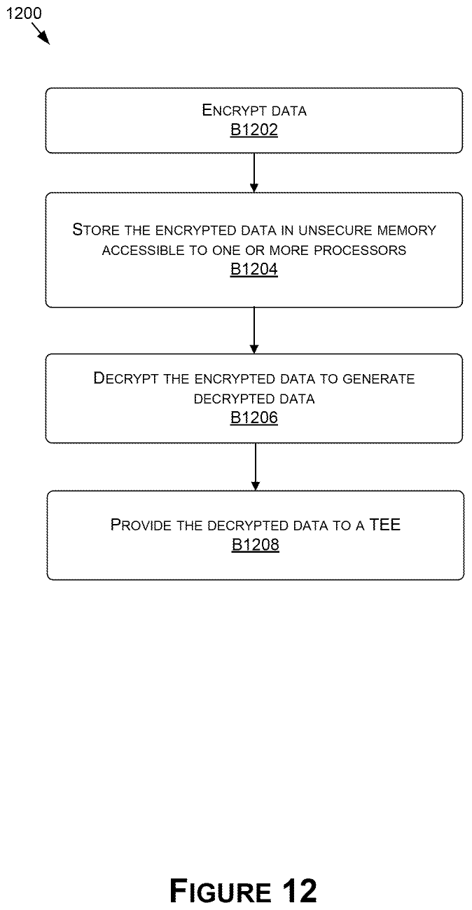

Referring now to FIG. 12, FIG. 12 is a flow diagram showing a method 1200 for copying data from GPU memory to CPU memory within a TEE that includes a PPU, in accordance with at least some embodiments of the present disclosure. The method 1200, at block B1202, includes encrypting data. For example, during the process of including the GPU 104 within the composite TEE 150, the secure processor 146 of the GPU 104 may generate a shared cryptographic key with the driver(s) 122 included in the CPU TEE 170. The shared cryptographic key may be used to encrypt data prior to transmission across the system bus 320 otherwise protect the data in transit between the GPU TEE 172 and the CPU TEE 170. In at least one embodiment, the data is stored in a protected memory region of the GPU memory.

At block B1204, the method 1200 includes storing the encrypted data in unsecure memory accessible to one or more processors. For example, the system 300 may store the encrypted data in an unsecure region of memory accessible to the CPU 102. In at least one embodiment, the memory accessor 130, after encrypting the data, transmits the data across the system bus 320 and causes the data to be stored in an unsecure memory region such as the unsecure memory region 318 described above in connection with FIG. 3.

At block B1206, the method 1200 includes decrypting the encrypted data to generate decrypted data. For example, the system 300 may decrypt the encrypted data with the shared cryptographic key. In at least one embodiment, the driver(s) 122 within the CPU TEE 170 store the cryptographic key and cause a guest operating system, drivers, and/or other components of the composite TEE 150 to open the encrypted data from the unsecure region and decrypt the encrypted data based at least on the shared cryptographic key.

At block B1208, the method 1100 includes providing the decrypted data to a TEE. For example, the encrypted data may include a result of an operation performed by the GPU 104. In addition, in various embodiments, providing the decrypted data to the composite TEE 150 includes causing the data in plain text to be stored in a secure memory region of the CPU memory protected by the composite TEE 150.

Confidential Computing Using Secure Multi-Instance PPUs

In accordance with aspects of the present disclosure, a PPU(s) may support multiple PPU instances, where different PPU instances may belong to different TEEs and provide accelerated confidential computing to a corresponding TEE. An instance of a PPU (or PPU instance) may refer to a partition of a PPU, or a virtual PPU, such that the partition of PPU appears as a PPU to external devices. An example of an instance of a PPU includes a multi-instance GPU (MIG). In at least one embodiment, a PPU may be securely partitioned into any number of PPU instances (where the number may be hardware limited), with each PPU instance providing (e.g., to different users, VMs, and/or devices) separate PPU resources, which may operate in parallel amongst the PPU instances.

In at least one embodiment, the processors of each PPU instance have separate and isolated paths through the memory system of the PPU—such as on-chip crossbar ports, L2 cache banks, memory controllers, and DRAM address busses—which are all assigned uniquely to an individual PPU instance. In doing so, a workload can run on a PPU instance with predictable throughput and latency, with the same L2 cache allocation and DRAM bandwidth, even if other tasks performed by other PPU instances are using their own caches or saturating their DRAM interfaces. In at least one embodiment, a PPU instance includes a partition of compute resources of the PPU, such as one or more compute units, and PPU engines such as copy engines or decoders.

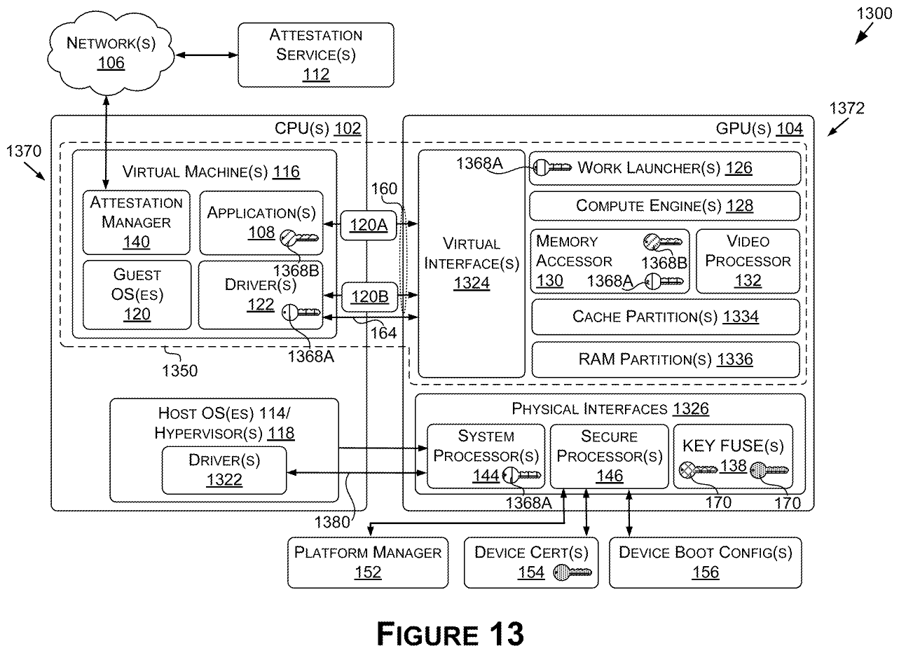

Referring now to FIG. 13, FIG. 13 depicts an example of a system 1300 including TEE having an instance of a PPU, in accordance with at least some embodiments of the present disclosure. For example, the system 1300 includes a TEE 1372 having an instance(s) of the GPU(s) 104. A composite TEE 1350 includes a CPU TEE 1370 corresponding to the CPU(s) 102 and a GPU instance TEE 1372 corresponding to the instance(s) of the GPU(s) 104.

In at least one embodiment, the CPU(s) 102 can support any number of CPU TEEs 1370 which may be part of any number of composite TEEs 1350. Each CPU TEE 1370 may include, for example, respective instances of an attestation manager 140, an application(s) 108, a guest OS(es) 120, and a driver(s) 122, as described herein. Further, the GPU(s) 104 can support any number of GPU instance TEEs 1372 which may be part of any number of composite TEEs 1350. Each GPU instance TEE 1372 may include, for example, respective instances of a virtual interface(s) 1324, a work launcher(s) 126, a compute engine(s) 128, a memory accessor(s) 130, a video processor(s) 132, a cache partition(s) 1334, and a RAM partition(s) 1336.

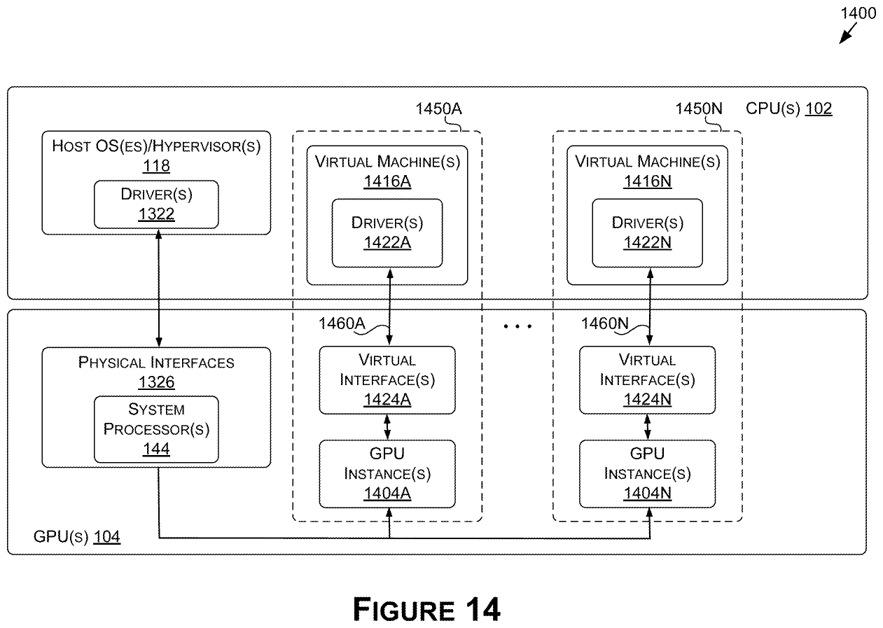

Referring now to FIG. 14, FIG. 14 depicts examples of configurations in a multi-instance PPU system 1400, in accordance with at least some embodiments of the present disclosure. In the example of FIG. 14, the CPU(s) 102 may be used to implement multiple VMs, any of which may use one or more PPU instances of one or more PPUs for hardware acceleration. The GPU(s) 104 may be partitioned into any number of the PPU instances, which may include, for example, GPU instances 1404A through 1404N, any of which may correspond to the GPU instance TEE 1372 of FIG. 13.

In at least one embodiment, FIG. 14 may correspond to a multi-instance GPU server and/or a multi-GPU server. Some of the GPUs and/or GPU instances may run in a non-confidential compute mode, while others may run in a confidential compute mode (e.g., in a single GPU configuration or a multi-GPU configuration).

An composite TEE 1450A, which may correspond to the composite TEE(s) 1350 of FIG. 13, includes a VM 1416A, which may correspond to a VM(s) 116 of FIG. 13, and may use the GPU instance 1404A for hardware acceleration within the composite TEE 1450A. For example, a driver(s) 1422A, which may correspond to a driver(s) 122 of FIG. 13, a communication channel(s) 1460A, which may correspond to a communication channel(s) 160 of FIG. 13, and a virtual interface(s) 1424A, which may correspond to a virtual interface(s) 1324 of FIG. 13, may be used to implement hardware acceleration using the GPU(s) 104.

A composite TEE 1450N, which may correspond to the composite TEE(s) 1350 of FIG. 13, includes a VM 1416N, which may correspond to a VM(s) 116 of FIG. 13, and may use the GPU instance 1404N for hardware acceleration within the composite TEE 1450N. For example, a driver(s) 1422N, which may correspond to a driver(s) 122 of FIG. 13, a communication channel(s) 1460N, which may correspond to a communication channel(s) 160 of FIG. 13, and a virtual interface(s) 1424N, which may correspond to a virtual interface(s) 1324 of FIG. 13, may be used to implement hardware acceleration using the GPU(s) 104.

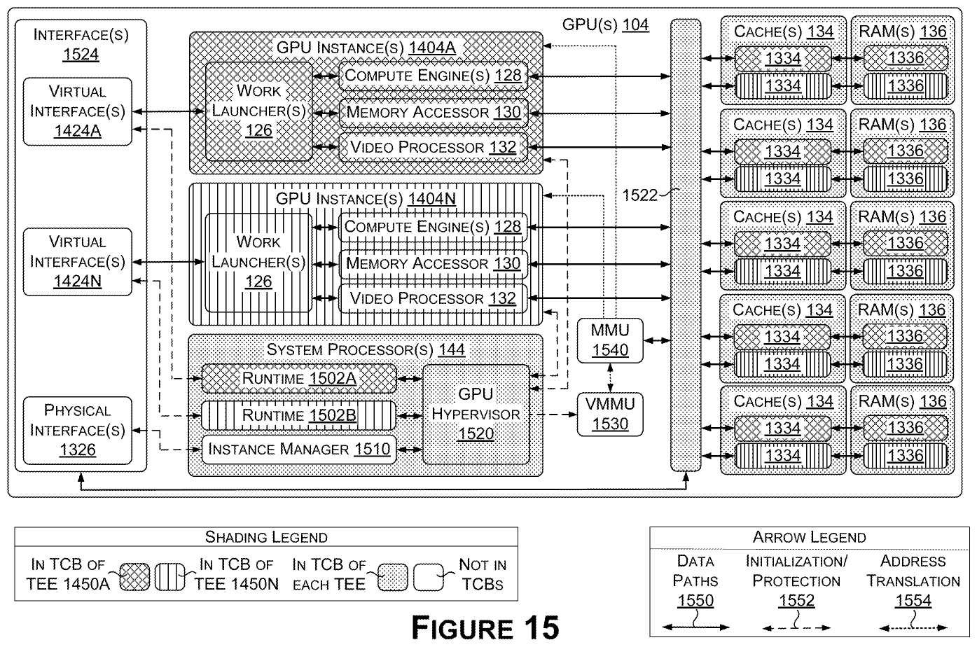

In at least one embodiment, the hypervisor 118 and/or host OS(s) 114 have in-band access to the GPU 104 using the physical interface(s) 1326 (e.g., a physical function) for management/tenant life-cycle functions for any number of the VM(s) 116. The management/tenant life-cycle functions may be performed using a driver(s) 1322, which may not have the ability to run graphics and compute applications but may be assigned the physical interface 1326 (e.g., a physical function). For example, the driver(s) 1322 may load the microcode of the system processor during boot of the GPU 104 over a communication channel(s) 1380 and reset the GPU 104, as described herein. Secure software running in the system processor(s) 144 may sanitize all inputs/outputs to ensure the hypervisor 118 and/or host OS(s) 114 do not have access to or cannot tamper with potentially sensitive and confidential data of the GPU instances. An example of the secure software includes an instance manager 1510 and/or a GPU hypervisor 1520 of FIG. 15.

In FIG. 13, the virtual interface(s) 1324 may correspond to the interface(s) 124 of FIG. 1, where the physical interface(s) 1326 (e.g., a PCIe interface) has been virtualized to provide the virtual interface(s) 1324. In at least one embodiment, a virtual interface(s) 1324, such as the virtual interface 1424A may be isolated from a virtual interface(s) 1324 assigned to another composite TEE 1350, such as the virtual interface 1424B using single root I/O virtualization (SR-IOV) and/or another virtualization technology. In one or more embodiments, each interface 1424 and/or VM 116(s) may be assigned a unique requester identifier (RID) that allows an MMU, such as an IOMMU of the GPU 104, to differentiate between different traffic streams and apply memory and interrupt translations between the interfaces 1424. This may allow traffic streams to be delivered directly to the appropriate partition and for traffic to be monitored using one or more hardware firewalls described herein, such as to identify and block external entities and/or to block requests corresponding to an unassigned partition.

In one or more embodiments, each VM 116(s) for each composite TEE 1350 may establish a separate secure session(s) with the GPU 104 that provides cryptographical and temporal isolation from each other using, for example, respective one or more shared symmetric session keys 1368A and/or 1368B, which may correspond to the one or more shared symmetric session keys 168A and/or 168B of FIG. 1 and may be referred to as a symmetric session key(s) 1368. Data in device memory of the GPU 104 may remain encrypted, as described herein, but may be isolated and access controlled using one or more hardware firewalls, as described herein. In at least one embodiment, when PPU instances are used with multiple tenants, each tenant may be allocated respective CPR memory and can indicate whether or not to create a non-CPR carve-out as needed. Like CPR memory, non-CPR memory regions may not be mapped across multiple tenants and hence isolated to a guest VM 116 that creates them.

Referring now to FIG. 15, FIG. 15 illustrates an example of a GPU 104 having isolated PPU instances, in accordance with at least some embodiments of the present disclosure. As indicated in FIG. 15, each GPU instance TEE 1372 may have independent units with respect to other GPU TEEs (if present), non-limiting examples of which include a work launcher 126, a compute engine 128, a memory accessor 130, a video processor 132, cache partitions 1334, RAM partitions 1336, a translation lookaside buffer(s), and/or a copy engine(s). Further, each GPU instance TEE 1372 may have independent channels in an interconnect 1522 (to corresponding RAM partitions 1336) with respect to other GPU instance TEEs (if present). Memory isolation may be provided using one or more hardware firewalls, as described herein. For example, one or more hardware firewalls may be used for first and second level translation paths outside of the TCB of a GPU instance TEE 1372.

As described herein, secure software, such as the instance manager 1510 and the GPU hypervisor 1520 may be used to sanitize all inputs/outputs to interfaces 1524 to ensure the hypervisor 118 and/or host OS(s) 114 do not have access to or cannot tamper with potentially sensitive and confidential data of the GPU instances 1404A through 1404N. The secure software may be used to establish independent execution partitions for a runtime 1502A corresponding to the GPU instance 1404A, a runtime 1502B corresponding to the GPU instance 140B, the instance manager 1510, and the GPU hypervisor 1520. In at least one embodiment, each runtime 1502 may be used to implement functionality described herein with respect to the system processor 144 for a corresponding GPU instance 1404. To this effect, each runtime 1502 may include and/or have access to a corresponding cryptographic key(s) 1368A (e.g., the key used by the kernel mode driver(s) 122). For example, LCEs may be assigned to a VM 116 based at least on a size of GPU instance 1404 allocated for the VM 116, with each LCE having its own key slots.

The secure software is shown as being included in the system processor(s) 144. In at least one embodiment, the secure software is included in one or more other processors and/or in multiple system processors (e.g., each of which may correspond to one or more GPU instances). For example, in at least one embodiment, a system processor 144 may be provided for each GPU instance 1404. In one or more embodiments, the system processor 144 may be provided for any number of the GPU instances 1404 of the GPU 104 (e.g., all of the GPU instances 1404). In at least one embodiment, the system processor 144 may be provided for multiple GPU instances 1404 using time slicing and/or other hardware sharing techniques for different runtimes 1502. In at least one embodiment, the runtime 1502a, the runtime 1502B, the instance manager 1510, and the GPU hypervisor 1520 may be on separate partitions, or trust domains, which may be implemented using a separation kernel.

In one or more embodiments, the instance manager 1510 configures the confidential compute mode, or a non-confidential compute mode of the GPU 104 and configures the GPU instances 1404. In at least one embodiment, the instance manager 1510 is configured to accept requests from the driver(s) 122 and/or the VM(s) 116 over the interface(s) 1524, such as the virtual interfaces 1424A and 1424N. The requests may be received in the form of one or more request packets that are decoded using the instance manager 1510 and may result in register writes and reads used to set up operations on the system processor(s) 144. In one or more embodiments, the instance manager 1510 may provide booting of the GPU 104, engine management, monitoring, and provisioning through a management interface. To do so, the instance manager 1510 may communicate with the GPU hypervisor 1520 using one or more APIs. In at least one embodiment, the instance manager 1510 generates the one or more attestation reports provided to a VM 116. In one or more embodiments, a separate attestation partition may generate the one or more attestation reports.

The instance manager 1510 may remain inactive and/or uninvolved in the running of workloads using the GPU instances 1404. In running workloads using the GPU instances 1404, the GPU instances 1404 may be operated concurrently and periodically using the communication channel(s) 1380. For example, new commands may be received over a remote procedure call (RPC) interface of the server, and through the virtual interfaces 1324 to be serviced using data paths 1550.

The GPU hypervisor 1520 may be configured to perform context switching when serving workload requests from the runtimes 1502 and dispatch the requests to the appropriate GPU instance 1404. The GPU hypervisor 1520 may be configured to isolate the runtimes 1502 from one another and ensure a runtime 1502 can only communicate with a GPU instance 1404 the runtime 1502 is assigned to manage. The GPU hypervisor 1520 may further use time slicing and/or other hardware sharing techniques to service the requests from the runtimes 1502. The GPU hypervisor 1520 may own hardware resources of the GPU 104 and access (e.g., all access) to the hardware of the GPU 104 may be granted by the GPU hypervisor 1520 based at least on assignments made by the GPU hypervisor 1520 of the hardware resources to the partitions and/or runtimes 1502. As opposed to a traditional hypervisor that performs access control and virtualization of hardware, the GPU hypervisor 1520 may function as a stateful firewall. For example, the GPU hypervisor 1520 may determine which entity can access what hardware resources and when. In one or more embodiments, when the GPU hypervisor 1520 assigns hardware resources to the runtimes 1502. The runtimes 1502 may directly access assigned hardware resources, but those hardware resources become inaccessible to the instance manager 1510.

As indicated in FIG. 15, the physical interface(s) 1326 (e.g., a physical function) connects to the system processor 144, along with a virtual interface 1424A or 1424N (e.g., virtual functions) for each of the GPU instances 1404A or 1404N. As described herein, the virtual interfaces 1424A or 1424N may be implemented using SR-IOV. The virtual interfaces 1424A and 1424N may expose all of the memory for a corresponding GPU instance that is available for access by a corresponding VM 116 over corresponding data paths 1550.

As indicated by the data paths 1550, a work launch may be received by the work launcher 126 of the GPU instance 1404A from the virtual interface 1424A, which may cause operation, for example, of the compute engine 128 (or the memory accessor 130, or the video processor 132). As a result, the compute engine 128 may read from and/or write to slices of the RAM partition(s) 1336 through the cache(s) 134 then, for example, write back to a different address or different RAM(s) 136. In this process, an MMU 1540 may use a virtual MMU (VMMU) 1530 to perform address translation 1554 to determine system physical addresses from virtual addresses associated with the GPU instance 1404A.

In at least one embodiment, a virtual interface for each GPU instance 1404 has access to a limited register space specific to the GPU instance 1404 and memory slices that are assigned to the GPU instance 1404 (e.g., by the instance manager 1510 during boot). For example, when each GPU instance 1404 is configured during boot (e.g., the secure and measured boot described herein), each GPU instance 1404 may be allocated exclusive use of resources of the GPU 104, such as the GPU resources indicated as corresponding to a particular GPU instance TEE 1372 in FIG. 13.

Thus, for example, if the GPU instance 1404A is fetching from the RAM 136, the GPU instance 1404A may only access the cache partition(s) 1334 and/or the RAM partition(s) 1336 corresponding to the TCB of the GPU TEE 1370. Aliasing of the cache 134 may not be used across memory segments.

Initialization/protection 1552 in FIG. 15 may include configuring memory management and hardware firewalls (e.g., during boot), mapping the virtual interfaces 1324 to corresponding runtimes 1502, allocating any of the various IDs to particular GPU instances 1404 and/or memory partitions, and/or using any of the various IDs to verify a memory access request. The initialization/protection 1552 may also include sending the cryptographic key(s) 1368 to the corresponding GPU instance 1404 for use by the memory accessor 130 of the GPU instance 1404 (e.g., during runtime after boot).

In configuring memory management for the GPU instances 1404, the VMMU 1530 (an MMU for managing virtual memory) may configure first level page tables based at least on which GPU instances 1404 have access to which physical pages of memory. Further, the MMU 1540 (e.g., the MMU described herein) may be configured by the driver 122 for the tenant and/or composite TEE 1350 to configure the page table mappings within the GPU instance 1404. When processing memory requests from a GPU instance 1404, the MMU 1540 may then use the VMMU 1530 for the address translation 1554.

In the event that the VMMU 1530 is compromised (e.g., improperly programmed), a GPU instance 1404 may be capable of accessing the memory of another GPU instance 1404. In at least one embodiment, one or more firewalls (e.g., implemented in the MMU 1540) may be used to mitigate the ability of the VMMU 1530 to be used in this manner. For example, the one or more firewalls may check segment and/or partition identifiers (IDs), such as swizzle IDs, of memory access requests and produce a fault or otherwise block access to corresponding memory if an access request falls outside a partitioned memory boundary corresponding to the segment ID(s).

In at least one embodiment, a segment ID may select which partition (e.g., the cache partition 1334) a GPU instance 1404 making a memory request is able to access. For example, when a GPU instance 1404 attempts to access local memory, the segment ID may define one or more ranges that are compared to the system physical address to determine the corresponding partition. Each GPU instance 1404 may be assigned one or more segment IDs, and memory requests from the GPU instance 1404 that indicate a segment ID that does not match the segment ID(s) assigned to the GPU instance 1404 may be blocked based at least on comparing the IDs. In one or more embodiments, a memory request may indicate one or more engine IDs (e.g., copy engine IDs), guest IDs (e.g., corresponding to a VM 116), and/or GPU instance IDs, which may depend on the entity initiating the request. Any combination of these IDs may be mapped to a segment ID. In one or more embodiments, when an entity makes a request, a corresponding entity ID may be mapped to a segment ID that is compared to an assigned segment ID to determine whether to block or allow the memory request.

In further respects, the one or more firewalls used (e.g., by the MMU 1540) to isolate data in device memory of the GPU 104 may use one or more segment masks. In at least one embodiment, the VMMU 1530 may implement one or more bit masks where each bit(s) corresponds to a segment(s) of memory. In at least one embodiment, the segment may each be of a fixed size, such as 32 megabytes each, which may be configurable using one or more registers. In one or more embodiments, the segment mask(s) may be stored in a data structure, such as a table, and indexed by or otherwise associated with any of the various IDs described herein, such as guest ID, indicating one or more entities assigned to the segment mask(s).

In one or more embodiments, when an entity makes a request, a corresponding entity ID and segment mask indicted by the request may be used to lookup the segment mask(s) that is compared to the segment mask indicated by the request to determine whether to block or allow the memory request. For example, when a request from an entity is received by the MMU 1540, the request may include a client ID and an engine ID. The client ID may indicate (e.g., be mapped to) a GPU instance ID, and the engine ID may indicate (e.g., be mapped to) the page tables to use to translate the request as well as indicating (e.g., being mapped to) the guest ID associated with the request (e.g., the guest ID of the guest the copy engine having the engine ID is assigned or bound to).

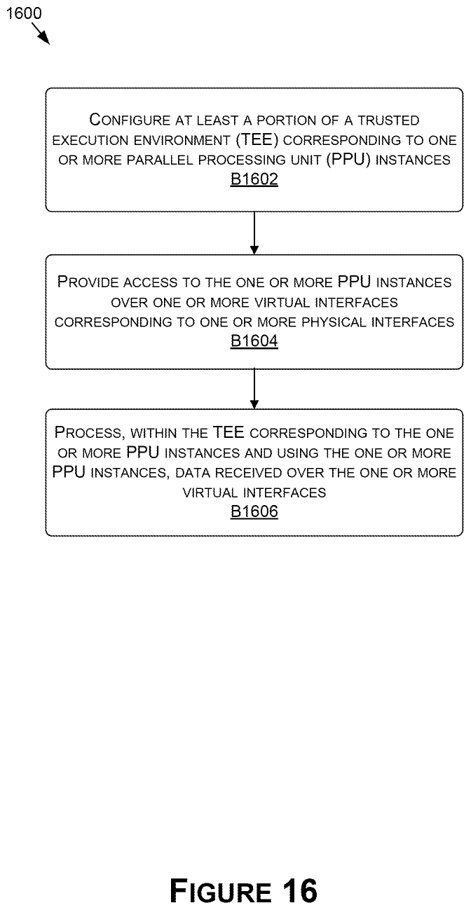

Referring now to FIG. 16, FIG. 16 is a flow diagram showing a method 1600 a PPU, such as a GPU(s) 104, may use to process data within a TEE using a PPU instance, in accordance with at least some embodiments of the present disclosure. The method 1600, at block B1602, includes configuring at least a portion of a TEE corresponding to one or more PPU instances. For example, the GPU 104 may configure the GPU instance TEE 1372 (e.g., using a secure and measured boot) corresponding to the GPU instance 1404A of the GPU 104.

At block B1604, the method 1600 includes providing access to the one or more PPU instances over one or more virtual interfaces corresponding to one or more physical interfaces. For example, the system processor 144 may provide, to the VM 116 in the CPU TEE 1370 corresponding to the CPU 102, access to the GPU instance 1404A over the virtual interface 1424A corresponding to the physical interface 1326.

At block B1606, the method 1600 includes processing, within the TEE corresponding to the one or more PPU instances and using the one or more PPU instances, data received over the one or more virtual interfaces. For example, the GPU instance 1404A may process, within the GPU instance TEE 1372, data received from the VM 116 over the virtual interface 1424A.

Example Computing Device

FIG. 17 is a block diagram of an example computing device(s) 1700 suitable for use in implementing some embodiments of the present disclosure. Computing device 1700 may include an interconnect system 1702 that directly or indirectly couples the following devices: memory 1704, one or more central processing units (CPUs) 1706, one or more graphics processing units (GPUs) 1708, a communication interface 1710, input/output (I/O) ports 1712, input/output components 1714, a power supply 1716, one or more presentation components 1718 (e.g., display(s)), and one or more logic units 1720. In at least one embodiment, the computing device(s) 1700 may comprise one or more virtual machines (VMs), and/or any of the components thereof may comprise virtual components (e.g., virtual hardware components). For non-limiting examples, one or more of the GPUs 1708 may comprise one or more vGPUs, one or more of the CPUs 1706 may comprise one or more vCPUs, and/or one or more of the logic units 1720 may comprise one or more virtual logic units. As such, a computing device(s) 1700 may include discrete components (e.g., a full GPU dedicated to the computing device 1700), virtual components (e.g., a portion of a GPU dedicated to the computing device 1700), or a combination thereof.

Although the various blocks of FIG. 17 are shown as connected via the interconnect system 1702 with lines, this is not intended to be limiting and is for clarity only. For example, in some embodiments, a presentation component 1718, such as a display device, may be considered an I/O component 1714 (e.g., if the display is a touch screen). As another example, the CPUs 1706 and/or GPUs 1708 may include memory (e.g., the memory 1704 may be representative of a storage device in addition to the memory of the GPUs 1708, the CPUs 1706, and/or other components). In other words, the computing device of FIG. 17 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 17.

The interconnect system 1702 may represent one or more links or busses, such as an address bus, a data bus, a control bus, or a combination thereof. The interconnect system 1702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1706 may be directly connected to the memory 1704. Further, the CPU 1706 may be directly connected to the GPU 1708. Where there is direct, or point-to-point connection between components, the interconnect system 1702 may include a PCIe link to carry out the connection. In these examples, a PCI bus need not be included in the computing device 1700.

The memory 1704 may include any of a variety of computer-readable media. The computer-readable media may be any available media that may be accessed by the computing device 1700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1706 may be configured to execute at least some of the computer-readable instructions to control one or more components of the computing device 1700 to perform one or more of the methods and/or processes described herein. The CPU(s) 1706 may each include one or more cores (e.g., one, two, four, eight, twenty-eight, seventy-two, etc.) that are capable of handling a multitude of software threads simultaneously. The CPU(s) 1706 may include any type of processor, and may include different types of processors depending on the type of computing device 1700 implemented (e.g., processors with fewer cores for mobile devices and processors with more cores for servers). For example, depending on the type of computing device 1700, the processor may be an Advanced RISC Machines (ARM) processor implemented using Reduced Instruction Set Computing (RISC) or an x86 processor implemented using Complex Instruction Set Computing (CISC). The computing device 1700 may include one or more CPUs 1706 in addition to one or more microprocessors or supplementary co-processors, such as math co-processors.

In addition to or alternatively from the CPU(s) 1706, the GPU(s) 1708 may be configured to execute at least some of the computer-readable instructions to control one or more components of the computing device 1700 to perform one or more of the methods and/or processes described herein. One or more of the GPU(s) 1708 may be an integrated GPU (e.g., with one or more of the CPU(s) 1706 and/or one or more of the GPU(s) 1708 may be a discrete GPU. In embodiments, one or more of the GPU(s) 1708 may be a coprocessor of one or more of the CPU(s) 1706. The GPU(s) 1708 may be used by the computing device 1700 to render graphics (e.g., 3D graphics) or perform general purpose computations. For example, the GPU(s) 1708 may be used for General-Purpose computing on GPUs (GPGPU). The GPU(s) 1708 may include hundreds or thousands of cores that are capable of handling hundreds or thousands of software threads simultaneously. The GPU(s) 1708 may generate pixel data for output images in response to rendering commands (e.g., rendering commands from the CPU(s) 1706 received via a host interface). The GPU(s) 1708 may include graphics memory, such as display memory, for storing pixel data or any other suitable data, such as GPGPU data. The display memory may be included as part of the memory 1704. The GPU(s) 1708 may include two or more GPUs operating in parallel (e.g., via a link). The link may directly connect the GPUs (e.g., using NVLINK) or may connect the GPUs through a switch (e.g., using NVSwitch). When combined together, each GPU 1708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1706 and/or the GPU(s) 1708, the logic unit(s) 1720 may be configured to execute at least some of the computer-readable instructions to control one or more components of the computing device 1700 to perform one or more of the methods and/or processes described herein. In embodiments, the CPU(s) 1706, the GPU(s) 1708, and/or the logic unit(s) 1720 may discretely or jointly perform any combination of the methods, processes and/or portions thereof. One or more of the logic units 1720 may be part of and/or integrated in one or more of the CPU(s) 1706 and/or the GPU(s) 1708 and/or one or more of the logic units 1720 may be discrete components or otherwise external to the CPU(s) 1706 and/or the GPU(s) 1708. In embodiments, one or more of the logic units 1720 may be a coprocessor of one or more of the CPU(s) 1706 and/or one or more of the GPU(s) 1708.

Examples of the logic unit(s) 1720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1710 may include one or more receivers, transmitters, and/or transceivers that enable the computing device 1700 to communicate with other computing devices via an electronic communication network, included wired and/or wireless communications. The communication interface 1710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1720 and/or communication interface 1710 may include one or more data processing units (DPUs) to transmit data received over a network and/or through interconnect system 1702 directly to (e.g., a memory of) one or more GPU(s) 1708.

The I/O ports 1712 may enable the computing device 1700 to be logically coupled to other devices including the I/O components 1714, the presentation component(s) 1718, and/or other components, some of which may be built in to (e.g., integrated in) the computing device 1700. Illustrative I/O components 1714 include a microphone, mouse, keyboard, joystick, game pad, game controller, satellite dish, scanner, printer, wireless device, etc. The I/O components 1714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1700. The computing device 1700 may be include depth cameras, such as stereoscopic camera systems, infrared camera systems, RGB camera systems, touchscreen technology, and combinations of these, for gesture detection and recognition. Additionally, the computing device 1700 may include accelerometers or gyroscopes (e.g., as part of an inertia measurement unit (IMU)) that enable detection of motion. In some examples, the output of the accelerometers or gyroscopes may be used by the computing device 1700 to render immersive augmented reality or virtual reality.

The power supply 1716 may include a hard-wired power supply, a battery power supply, or a combination thereof. The power supply 1716 may provide power to the computing device 1700 to enable the components of the computing device 1700 to operate.

The presentation component(s) 1718 may include a display (e.g., a monitor, a touch screen, a television screen, a heads-up-display (HUD), other display types, or a combination thereof), speakers, and/or other presentation components. The presentation component(s) 1718 may receive data from other components (e.g., the GPU(s) 1708, the CPU(s) 1706, DPUs, etc.), and output the data (e.g., as an image, video, sound, etc.).

Example Data Center

FIG. 18 illustrates an example data center 1800 that may be used in at least one embodiments of the present disclosure. The data center 1800 may include a data center infrastructure layer 1810, a framework layer 1820, a software layer 1830, and/or an application layer 1840.

As shown in FIG. 18, the data center infrastructure layer 1810 may include a resource orchestrator 1812, grouped computing resources 1814, and node computing resources (“node C.R.s”) 1816(1)-1816(N), where “N” represents any whole, positive integer. In at least one embodiment, node C.R.s 1816(1)-1816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1816(1)-1816(N) may correspond to a server having one or more of the above-mentioned computing resources. In addition, in some embodiments, the node C.R.s 1816(1)-18161(N) may include one or more virtual components, such as vGPUs, vCPUs, and/or the like, and/or one or more of the node C.R.s 1816(1)-1816(N) may correspond to a virtual machine (VM).

In at least one embodiment, grouped computing resources 1814 may include separate groupings of node C.R.s 1816 housed within one or more racks (not shown), or many racks housed in data centers at various geographical locations (also not shown). Separate groupings of node C.R.s 1816 within grouped computing resources 1814 may include grouped compute, network, memory or storage resources that may be configured or allocated to support one or more workloads. In at least one embodiment, several node C.R.s 1816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1812 may configure or otherwise control one or more node C.R.s 1816(1)-1816(N) and/or grouped computing resources 1814. In at least one embodiment, resource orchestrator 1812 may include a software design infrastructure (SDI) management entity for the data center 1800. The resource orchestrator 1812 may include hardware, software, or some combination thereof.

In at least one embodiment, as shown in FIG. 18, framework layer 1820 may include a job scheduler 1828, a configuration manager 1834, a resource manager 1836, and/or a distributed file system 1838. The framework layer 1820 may include a framework to support software 1832 of software layer 1830 and/or one or more application(s) 1842 of application layer 1840. The software 1832 or application(s) 1842 may respectively include web-based service software or applications, such as those provided by Amazon Web Services, Google Cloud and Microsoft Azure. The framework layer 1820 may be, but is not limited to, a type of free and open-source software web application framework such as Apache Spark™ (hereinafter “Spark”) that may utilize distributed file system 1838 for large-scale data processing (e.g., “big data”). In at least one embodiment, job scheduler 1828 may include a Spark driver to facilitate scheduling of workloads supported by various layers of data center 1800. The configuration manager 1834 may be capable of configuring different layers such as software layer 1830 and framework layer 1820 including Spark and distributed file system 1838 for supporting large-scale data processing. The resource manager 1836 may be capable of managing clustered or grouped computing resources mapped to or allocated for support of distributed file system 1838 and job scheduler 1828. In at least one embodiment, clustered or grouped computing resources may include grouped computing resource 1814 at data center infrastructure layer 1810. The resource manager 1836 may coordinate with resource orchestrator 1812 to manage these mapped or allocated computing resources.

In at least one embodiment, software 1832 included in software layer 1830 may include software used by at least portions of node C.R.s 1816(1)-1816(N), grouped computing resources 1814, and/or distributed file system 1838 of framework layer 1820. One or more types of software may include, but are not limited to, Internet web page search software, e-mail virus scan software, database software, and streaming video content software.

In at least one embodiment, application(s) 1842 included in application layer 1840 may include one or more types of applications used by at least portions of node C.R.s 1816(1)-1816(N), grouped computing resources 1814, and/or distributed file system 1838 of framework layer 1820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1834, resource manager 1836, and resource orchestrator 1812 may implement any number and type of self-modifying actions based on any amount and type of data acquired in any technically feasible fashion. Self-modifying actions may relieve a data center operator of data center 1800 from making possibly bad configuration decisions and possibly avoiding underutilized and/or poor performing portions of a data center.

The data center 1800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1800. In at least one embodiment, trained or deployed machine learning models corresponding to one or more neural networks may be used to infer or predict information using resources described above with respect to the data center 1800 by using weight parameters calculated through one or more training techniques, such as but not limited to those described herein.

In at least one embodiment, the data center 1800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1700 of FIG. 17—e.g., each device may include similar components, features, and/or functionality of the computing device(s) 1700. In addition, where backend devices (e.g., servers, NAS, etc.) are implemented, the backend devices may be included as part of a data center 1800, an example of which is described in more detail herein with respect to FIG. 18.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1700 described herein with respect to FIG. 17. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
establishing one or more secure communication channels between one or more virtual machines (VMs) executing within a trusted execution environment (TEE) corresponding to one or more processors and a TEE corresponding to one or more parallel processing units (PPUs);
receiving, using the one or more secure communication channels, data from the one or more virtual machines (VMs) executing within the TEE corresponding to the one or more processors; and
processing the data within the TEE corresponding to the one or more PPUs using the one or more PPUs.

2. The method of claim 1, further comprising:
decrypting, within the TEE corresponding to the one or more PPUs, the data received using the one or more secure communication channels to generate decrypted data; and
storing the decrypted data in one or more protected memory regions of the TEE corresponding to the one or more PPUs, wherein the processing the data includes accessing the decrypted data from the one or more protected memory regions.

3. The method of claim 2, wherein the decrypting is performed using one or more secure processors corresponding to the one or more PPUs.

4. The method of claim 1, further comprising scrubbing one or more memory regions used to store the data received using the one or more secure communication channels.

5. The method of claim 1, further comprising configuring the TEE using a secure boot sequence corresponding to the one or more PPUs.

6. The method of claim 1, wherein the receiving of the data is from one or more bounce buffers outside of the TEE corresponding to the one or more PPUs and the TEE corresponding to the one or more processors.

7. The method of claim 1, wherein the one or more secure communication channels correspond to one or more interfaces, the one or more interfaces being provided to the one or more VMs using one or more hypervisors external to the TEE corresponding to the one or more processors and the TEE corresponding to the one or more PPUs.

8. The method of claim 1, further comprising:
generating one or more encrypted attestation reports indicating one or more properties of the TEE corresponding to the one or more processors; and
providing the one or more encrypted attestation reports to the one or more VMs, wherein the receiving of the data is based at least on the one or more properties of the TEE being verified using the one or more VMs.

9. The method of claim 1, further comprising:
receiving one or more requests for the one or more PPUs to enter a secure execution mode; and
responsive to the one or more requests, resetting the one or more PPUs and configuring of the TEE corresponding to the one or more PPUs.

10. The method of claim 1, wherein the one or more PPUs include one or more graphics processing units (GPUs) and the one or more processors include one or more central processing units (CPUs).

11. A system comprising:
one or more processors to perform operations including:
receiving, by one or more virtual machines (VMs) in a trusted execution environment (TEE) corresponding to the one or more processors, access to one or more parallel processing units (PPUs) over one or more interfaces;
encrypting, in the TEE corresponding to the one or more processors, data associated with the one or more virtual machines (VMs) to generate encrypted data;
providing the encrypted data over the one or more interfaces to cause:
decryption of the encrypted data in a TEE corresponding to the one or more PPUs to generate decrypted data; and
processing of the decrypted data in the TEE corresponding to the one or more PPUs using the one or more PPUs.

12. The system of claim 11, wherein the access is provided using one or more hypervisors outside of the TEE corresponding to the one or more processors, and encrypting is performed using one or more cryptographic keys that are inaccessible to the one or more hypervisors.

13. The system of claim 11, wherein the operations further include:
receiving in the TEE corresponding to the one or more processors and over the one or more interfaces, one or more encrypted results corresponding to the processing of the decrypted data using the one or more PPUs;
decrypting, in the TEE corresponding to the one or more processors, the one or more encrypted results to generate one or more unencrypted results; and
processing the one or more unencrypted results using the one or more VMs in the TEE corresponding to the one or more processors.

14. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing generative AI operations;
a system for performing operations using a large language model;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system implemented at least partially in a data center; or
a system implemented at least partially using cloud computing resources.

15. A processor comprising:
one or more circuits to process data using one or more parallel processing units (PPUs) in a trusted execution environment (TEE) corresponding to the one or more PPUs based at least on receiving, using one or more secure communication channels between one or more virtual machines (VMs) executing within a TEE corresponding to one or more processors and the TEE corresponding to the one or more PPUs, data from the one or more virtual machines (VMs).

16. The processor of claim 15, wherein the data is accessed, for the processing, from one or more protected memory regions of the TEE corresponding to the one or more PPUs.

17. The processor of claim 15, wherein the data is received using one or more secure processors corresponding to the one or more PPUs.

18. The processor of claim 15, wherein the one or more secure communication channels correspond to one or more interfaces, the one or more interfaces being provided to the one or more VMs using one or more hypervisors external to the TEE corresponding to the one or more processors and the TEE corresponding to the one or more PPUs.

19. The processor of claim 15, further comprising providing one or more results of the processing to the one or more virtual machines (VMs) using the one or more secure communication channels.

20. The processor of claim 15, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing generative AI operations;
a system for performing operations using a large language model;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
